(19) United States
(12) Patent Application Publication
(10) Pub. No.: US 2019/0130586 A1
(43) Pub. Date: May 2, 2019

(54) ROBUST SLEEPING OBJECT DETECTION IN VIDEO ANALYTICS

(71) Applicant: QUALCOMM Incorporated, San Diego, CA (US)

(72) Inventors: Yang ZHOU, San Jose, CA (US); Ying CHEN, San Diego, CA (US); Ning BI, San Diego, CA (US)

(21) Appl. No.: 16/159,346

(22) Filed: Oct. 12, 2018

Related U.S. Application Data
(60) Provisional application No. 62/579,038, filed on Oct. 30, 2017.

(51) Int. Cl. G06T 7/246; G06T 7/90; G06T 7/194

(52) U.S. Cl. CPC G06T 7/246; G06T 7/90; G06T 7/194; H04N 5/225; G06T 2207/30232; G06T 2207/20224; G06T 2207/10016

(57) ABSTRACT

Provided are systems, methods, and computer-readable medium for maintaining blob trackers for video frames. The techniques and systems described herein identify a candidate sleeping tracker that is a false positive. In some examples, a false positive candidate sleeping tracker can be identified when an object associated with the candidate sleeping tracker was split from a previous object, and the object is within a target sleeping bounding region for the candidate sleeping tracker. The tracker for the object can be assigned a state that indicates that the blob will not continue to be tracked when the blob is detected as background. In some examples, a false positive candidate sleeping tracker can be identified when a maturity or age for the candidate sleeping tracker in insufficient.

### CROSS-REFERENCE TO RELATED APPLICATIONS

This application claims the benefit of U.S. Provisional Application No. 62/579,038, filed Oct. 30, 2017, which is hereby incorporated by reference, in its entirety and for all purposes.

### FIELD

The present disclosure generally relates to video analytics, and more specifically to techniques and systems for removing false positive detection of sleeping object trackers.

### BACKGROUND

Many devices and systems allow a scene to be captured by generating video data of the scene. For example, an Internet protocol camera (IP camera) is a type of digital video camera that can be employed for surveillance or other applications. Unlike analog closed circuit television (CCTV) cameras, an IP camera can send and receive data via a computer network and the Internet. The video data from these devices and systems can be captured and output for processing and/or consumption.

Video analytics, also referred to as Video Content Analysis (VCA), is a generic term used to describe computerized processing and analysis of a video sequence acquired by a camera. Video analytics provides a variety of tasks, including immediate detection of events of interest, analysis of pre-recorded video for the purpose of extracting events in a long period of time, and many other tasks. For instance, using video analytics, a system can automatically analyze the video sequences from one or more cameras to detect one or more events. In some cases, video analytics can send alerts or alarms for certain events of interest. More advanced video analytics is needed to provide efficient and robust video sequence processing.

### BRIEF SUMMARY

In some embodiments, techniques and systems are described for maintaining object trackers (also referred to as blob trackers) in video analytics to identify candidate sleeping trackers that are false positives. A blob represents at least a portion of one or more objects in a video frame (also referred to as a “picture”). In some examples, using video analytics, blob detection can be performed for one or more video frames to generate or identify blobs for the one or more video frames. Temporal information of the blobs can be used to identify stable objects or blobs so that a tracking layer can be established. After the blob detection process, trackers can be associated with the blobs. In some cases, over the course of several frames, a blob may be still, such that pixels from the blob will begin to be detected as background pixels. In some cases, the blob should continue to be tracked (e.g., as a sleeping object), while in other cases, the blob should be allowed to be detected as background (referred to herein as being absorbed into the background).

The techniques and systems described herein can operate to identify a candidate sleeping tracker that is a false positive. In some examples, a false positive candidate sleeping tracker can be identified when an object associated with the candidate sleeping tracker was split from a previous object, and the object is within a target sleeping bounding box for the candidate sleeping tracker. In some examples, a false positive candidate sleeping tracker can be identified when a maturity or age for the candidate sleeping tracker in insufficient.

According to at least one example, a method of maintaining blob trackers for video frames is provided that includes identifying a first blob tracker maintained for a current video frame, wherein the first blob tracker is associated with a blob detected in one or more video frames, the blob including pixels of at least a portion of a foreground object in the one or more video frames. The method further includes determining that at least a portion of the blob is being detected as background for the one or more video frames, wherein the first blob tracker associated with the blob is associated with a bounding region, wherein the bounding region can be used to track the blob when at least a portion of the blob is being detected as background. The method further includes determining that the blob is associated with a split group, the split group including one or more additional blobs, wherein each blob in the split group is associated with at least one blob tracker from a set of blob trackers, the set of blob trackers including all the blob trackers for the blobs in the split group. The method further includes determining that a second blob tracker from the set of blob trackers for the split group overlaps with at least a portion of the bounding region associated with the first blob tracker. The method further includes assigning a state to the first blob tracker based on the second blob tracker overlapping with at least the portion of the bounding region, wherein the state indicates that the blob will not continue to be tracked when the blob is detected as background.

In another example, an apparatus is provided that includes a memory configured to store video data and a processor coupled to the memory. The processor is configured to and can identify a first blob tracker maintained for a current video frame, wherein the first blob tracker is associated with a blob detected in one or more video frames, the blob including pixels of at least a portion of a foreground object in the one or more video frames. The processor is configured to and can determine that at least a portion of the blob is being detected as background for the one or more video frames, wherein the first blob tracker associated with the blob is associated with a bounding region, wherein the bounding region can be used to track the blob when at least a portion of the blob is being detected as background. The processor is configured to and can determine that the blob is associated with a split group, the split group including one or more additional blobs, wherein each blob in the split group is associated with at least one blob tracker from a set of blob trackers, the set of blob trackers including all the blob trackers for the blobs in the split group. The processor is configured to and can determine that a second blob tracker from the set of blob trackers for the split group overlaps with at least a portion of the bounding region associated with the first blob tracker. The processor is configured to and can assign a state to the blob tracker based on the second blob tracker overlapping with at least the portion of the bounding region, wherein the state indicates that the blob will not continue to be tracked when the blob is detected as background.

In another example, a computer readable medium is provided having stored thereon instructions that when executed by a processor perform a method that includes: identifying a first blob tracker maintained for a current video frame, wherein the first blob tracker is associated with a blob detected in one or more video frames, the blob including pixels of at least a portion of a foreground object in the one or more video frames. The method further includes determining that at least a portion of the blob is being detected as background for the one or more video frames, wherein the first blob tracker associated with the blob is associated with a bounding region, wherein the bounding region can be used to track the blob when at least a portion of the blob is being detected as background. The method further includes determining that the blob is associated with a split group, the split group including one or more additional blobs, wherein each blob in the split group is associated with at least one blob tracker from a set of blob trackers, the set of blob trackers including all the blob trackers for the blobs in the split group. The method further includes determining that a second blob tracker from the set of blob trackers for the split group overlaps with at least a portion of the bounding region associated with the first blob tracker The method further includes assigning a state to the first blob tracker based on the second blob tracker overlapping with at least the portion of the bounding region, wherein the state indicates that the blob will not continue to be tracked when the blob is detected as background.

In another example, an apparatus is provided that includes means for identifying a first blob tracker maintained for a current video frame, wherein the first blob tracker is associated with a blob detected in one or more video frames, the blob including pixels of at least a portion of a foreground object in the one or more video frames. The apparatus further comprises means for determining that at least a portion of the blob is being detected as background for the one or more video frames, wherein the first blob tracker associated with the blob is associated with a bounding region, wherein the bounding region can be used to track the blob when at least a portion of the blob is being detected as background. The apparatus further comprises means for determining that the blob is associated with a split group, the split group including one or more additional blobs, wherein each blob in the split group is associated with at least one blob tracker from a set of blob trackers, the set of blob trackers including all the blob trackers for the blobs in the split group. The apparatus further comprises means for determining that a second blob tracker from the set of blob trackers for the split group overlaps with at least a portion of the bounding region associated with the first blob tracker. The apparatus further includes a means for assigning a state to the first blob tracker based on the second blob tracker overlapping with at least the portion of the bounding region, wherein the state indicates that the blob will not continue to be tracked when the blob is detected as background.

In some aspects of the methods, apparatuses, and computer-readable medium described above, the second blob tracker from the set of blob trackers overlaps with at least the portion of the bounding region when the second blob tracker overlaps the bounding region by a threshold amount.

In some aspects, the methods, apparatuses, and computer readable medium described above further comprise determining that the second blob tracker from the set of blob trackers is not a lost blob tracker, wherein a lost blob tracker is associated with a blob that is not detected in the current video frame. These aspects further comprise assigning the state to the blob tracker based on the second blob tracker overlapping with at least the portion of the bounding region and based on the second blob tracker not being a lost blob tracker.

In some aspects, when all blob trackers from the set of blob trackers are lost or do not overlap with at least a portion of the bounding region, the first blob tracker is transitioned to a sleeping state, wherein the sleeping state enables the first blob tracker to track the blob for the current video frame.

In some aspects, the split group results from a single blob detected in a previous video frame being detected as the blob and the one or more additional blobs in a subsequent video frame, the subsequent video frame occurring later in time than the previous video frame.

In some aspects, determining that at least a portion of the blob is being detected as background includes determining that a current bounding region associated with the blob has decreased in size relative to a size of a previous bounding region associated with the blob. These aspects further include determining that a color characteristic of pixels associated with the current bounding region are similar to a color characteristic of pixels associated with the previous bounding region.

In some aspects, the bounding region can be used to track a sleeping object, wherein a sleeping object is associated with a blob that is still over multiple video frames.

In some aspects, the apparatus as described above can further comprise a camera for capturing the video frames. In some aspects, the apparatus comprises a mobile device with a camera for capturing the video frames. In some aspects, the apparatus further comprises a display for displaying the video frames.

According to at least one example, a method of maintaining blob trackers for video frames is provided that includes identifying a blob tracker maintained for a current video frame, wherein the blob tracker is associated with a blob detected in one or more video frames, the blob including pixels of at least a portion of a foreground object in the one or more video frames. The method further includes determining that at least a portion of the blob is being detected as background for the one or more video frames. The method further includes determining a maturity for the blob using the blob tracker, wherein the blob tracker includes a history for the blob, and wherein the maturity indicates a duration for the blob and a degree of movement for the blob. The method further includes determining that the maturity for the blob is below a threshold. The method further includes assigning a state to the blob tracker based on the maturity for the blob being below the threshold, wherein the state indicates that the blob will not continue to be tracked when the blob is detected as background.

In another example, an apparatus is provided that includes a memory configured to store video data and a processor. The processor is configured to and can identify a blob tracker maintained for a current video frame, wherein the blob tracker is associated with a blob detected in one or more video frames, the blob including pixels of at least a portion of a foreground object in the one or more video frames. The processor is configured to and can determine that at least a portion of the blob is being detected as background for the one or more video frames. The processor is configured to and can determine a maturity for the blob using the blob tracker, wherein the blob tracker includes a history for the blob, and wherein the maturity indicates a duration for the blob and a degree of movement for the blob. The processor is configured to and can determine that the maturity for the blob is below a threshold. The processor is configured to and can assign a state to the blob tracker based on the maturity for the blob being below the threshold, wherein the state indicates that the blob will not continue to be tracked when the blob is detected as background.

In another example, a computer readable medium is provided having stored thereon instructions that when executed by a processor perform a method that includes: identifying a blob tracker maintained for a current video frame, wherein the blob tracker is associated with a blob detected in one or more video frames, the blob including pixels of at least a portion of a foreground object in the one or more video frames. The method further includes determining that at least a portion of the blob is being detected as background for the one or more video frames. The method further includes determining a maturity for the blob using the blob tracker, wherein the blob tracker includes a history for the blob, and wherein the maturity indicates a duration for the blob and a degree of movement for the blob. The method further includes determining that the maturity for the blob is below a threshold. The method further includes assigning a state to the blob tracker based on the maturity for the blob being below the threshold, wherein the state indicates that the blob will not continue to be tracked when the blob is detected as background.

In another example, an apparatus is provided that includes means for identifying a blob tracker maintained for a current video frame, wherein the blob tracker is associated with a blob detected in one or more video frames, the blob including pixels of at least a portion of a foreground object in the one or more video frames. The apparatus further comprises means for determining that at least a portion of the blob is being detected as background for the one or more video frames. The apparatus further comprises means for determining a maturity for the blob using the blob tracker, wherein the blob tracker includes a history for the blob, and wherein the maturity indicates a duration for the blob and a degree of movement for the blob. The apparatus further comprises means for determining that the maturity for the blob is below a threshold. The apparatus further comprises means for assigning a state to the blob tracker based on the maturity for the blob being below the threshold, wherein the state indicates that the blob will not continue to be tracked when the blob is detected as background.

In some aspects of the methods, apparatuses, and computer-readable medium described above, the duration includes a count of video frames since the blob tracker and the blob were output as a tracker-blob pair.

In some aspects, the history for the blob includes a set of bounding regions determined for the blob for a set of previous video frames, and wherein the degree of movement is determined using coordinates for the set of bounding regions.

In some aspects, wherein the maturity for the blob is below the threshold when the duration for the blob is below a duration threshold.

In some aspects, the maturity for the blob is below the threshold when the degree of movement for the blob is below a movement threshold.

In some aspects, when the duration for the blob is greater than or equal to a duration threshold and the degree of movement is greater than or equal to a movement threshold, the blob tracker is transitioned to a sleeping state, wherein the sleeping state enables the blob tracker to track the blob for the current video frame.

In some aspects, determining that at least a portion of the blob is being detected as background includes determining that a current bounding region associated with the blob has decreased in size relative to a size of a previous bounding region associated with the blob. These aspects further include determining that a color characteristic of pixels associated with the current bounding region are similar to a color characteristic of pixels associated with the previous bounding region.

In some aspects, the apparatus as described above can further comprise a camera for capturing the video frames. In some aspects, the apparatus comprises a mobile device with a camera for capturing the video frames. In some aspects, the apparatus further comprises a display for displaying the video frames.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The foregoing, together with other features and embodiments, will become more apparent upon referring to the following specification, claims, and accompanying drawings.

FIG. 1 is a block diagram illustrating an example of a system including a video source and a video analytics system, in accordance with some embodiments.

FIG. 2 is an example of a video analytics system processing video frames, in accordance with some embodiments.

FIG. 3 is a block diagram illustrating an example of a blob detection engine, in accordance with some embodiments.

FIG. 4 is a block diagram illustrating an example of an object tracking engine, in accordance with some embodiments.

FIG. 5 illustrates an example of states that a tracker can undergo through the course of a tracker's existence.

FIG. 6 is an illustration of video frames of an environment for which a sleeping object is detected and tracked using a simple background subtraction based solution.

FIG. 7 shows an example of a sleeping object detection system that can be used to perform a sleeping object detection process.

FIG. 8A is a flowchart illustrating an example of a sleeping object detection process for detecting sleeping objects and trackers in a scene.

FIG. 8B illustrates a process that can be performed to determine whether to transition the current tracker to the sleeping state.

FIG. 9 illustrates an example of a sleeping object detection system that includes a false positive checker.

FIG. 10 illustrates an example of a process for sleeping object detection that includes false positives review sub-process.

FIG. 11 illustrates an example sequence of video frames in which an object may be detected by the sleeping object detection system as a sleeping object.

FIG. 12 illustrates an example of a sequence of video frames that include an object that may be detected as a sleeping object.

FIG. 13 illustrates an example of a process for checking candidate sleeping trackers as possible false positives.

FIG. 14 illustrates an example of a process for checking candidate sleeping trackers as possible false positives.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video analytics system can obtain a sequence of video frames from a video source and can process the video sequence to perform a variety of tasks. One example of a video source can include an Internet protocol camera (IP camera) or other video capture device. An IP camera is a type of digital video camera that can be used for surveillance, home security, or other suitable application. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

An IP camera can be used to send and receive data via a computer network and the Internet. In some cases, IP camera systems can be used for two-way communications. For example, data (e.g., audio, video, metadata, or the like) can be transmitted by an IP camera using one or more network cables or using a wireless network, allowing users to communicate with what they are seeing. In one illustrative example, a gas station clerk can assist a customer with how to use a pay pump using video data provided from an IP camera (e.g., by viewing the customer's actions at the pay pump). Commands can also be transmitted for pan, tilt, zoom (PTZ) cameras via a single network or multiple networks. Furthermore, IP camera systems provide flexibility and wireless capabilities. For example, IP cameras provide for easy connection to a network, adjustable camera location, and remote accessibility to the service over Internet. IP camera systems also provide for distributed intelligence. For example, with IP cameras, video analytics can be placed in the camera itself. Encryption and authentication is also easily provided with IP cameras. For instance, IP cameras offer secure data transmission through already defined encryption and authentication methods for IP based applications. Even further, labor cost efficiency is increased with IP cameras. For example, video analytics can produce alarms for certain events, which reduces the labor cost in monitoring all cameras (based on the alarms) in a system.

Video analytics provides a variety of tasks ranging from immediate detection of events of interest, to analysis of pre-recorded video for the purpose of extracting events in a long period of time, as well as many other tasks. Various research studies and real-life experiences indicate that in a surveillance system, for example, a human operator typically cannot remain alert and attentive for more than 20 minutes, even when monitoring the pictures from one camera. When there are two or more cameras to monitor or as time goes beyond a certain period of time (e.g., 20 minutes), the operator's ability to monitor the video and effectively respond to events is significantly compromised. Video analytics can automatically analyze the video sequences from the cameras and send alarms for events of interest. This way, the human operator can monitor one or more scenes in a passive mode. Furthermore, video analytics can analyze a huge volume of recorded video and can extract specific video segments containing an event of interest.

Video analytics also provides various other features. For example, video analytics can operate as an Intelligent Video Motion Detector by detecting moving objects and by tracking moving objects. In some cases, the video analytics can generate and display a bounding box around a valid object. Video analytics can also act as an intrusion detector, a video counter (e.g., by counting people, objects, vehicles, or the like), a camera tamper detector, an object left detector, an object/asset removal detector, an asset protector, a loitering detector, and/or as a slip and fall detector. Video analytics can further be used to perform various types of recognition functions, such as face detection and recognition, license plate recognition, object recognition (e.g., bags, logos, body marks, or the like), or other recognition functions. In some cases, video analytics can be trained to recognize certain objects. Another function that can be performed by video analytics includes providing demographics for customer metrics (e.g., customer counts, gender, age, amount of time spent, and other suitable metrics). Video analytics can also perform video search (e.g., extracting basic activity for a given region) and video summary (e.g., extraction of the key movements). In some instances, event detection can be performed by video analytics, including detection of fire, smoke, fighting, crowd formation, or any other suitable even the video analytics is programmed to or learns to detect. A detector can trigger the detection of an event of interest and can send an alert or alarm to a central control room to alert a user of the event of interest.

As described in more detail herein, a video analytics system can generate and detect foreground blobs that can be used to perform various operations, such as object tracking (also called blob tracking) or some of the other operations described above. A blob tracker (also referred to as an object tracker) can be used to track one or more blobs in a video sequence. In some cases, a tracked blob can be considered as an object. A blob tracker can start to be associated with a blob in one frame, and can continue to be associated with the blob across one or more subsequent frames. In some situations, a blob may stop moving for long enough to start becoming absorbed (or “vanish”) into the background model for the scene (e.g., as the blob or portions of the blob starts to become detected as background by background subtraction and/or other functions of a blob detection system). The blob, however, may be one that should continue to be tracked, even when the blob (or portions thereof) is detected as background. The video analytics system can include a sleeping object detection system for these situations. When a blob begins to vanish into the background, the sleeping object detection system can transition a tracker for the blob to a sleeping state. Should the blob start to move again, the prior history of the blob can be preserved by the tracker in the sleeping state.

In some situations, however, the sleeping object detection system may incorrectly identify blobs as sleeping objects. For example, an object may split into two or more objects, where each of the objects that resulted from the split can be tracked by individual blob trackers. One of the objects may remain stationary, because the object is, in fact, part of the background. For example, the object may be a door, a curtain, a chair, or some other item that is part of the background. In this example, the stationary object may gradually be absorbed into the background model, and can be falsely detected as a sleeping object.

As another example, a background object may occasionally move without an interaction with another object. For example, a curtain or tree can move due to air currents. In this example, the movement may be large enough and for long enough for the video analytics system to begin tracking the object with an object tracker. Once the object stops moving, however, the object may begin to vanish into the background. The sleeping object detection system may then incorrectly identify the object as a sleeping object.

In various implementations, a sleeping object detection system can include a false positive checker, to identify false positives such as those discussed above. The false positive checker can include a test for relevant trackers. An example of relevant trackers includes the split trackers that split from a same object, where one of the split trackers is being considered as a possible sleeping tracker. When a split tracker from the group is within the target sleeping bounding box of the candidate sleeping tracker, then the candidate sleeping tracker should not become a sleeping tracker. Instead, the object associated with the candidate sleeping tracker is allowed to be absorbed into the background.

In various implementations, the false positive checker can alternatively or additionally include a maturity test. The maturity test can examine the age, in terms of video frames, of a candidate sleeping tracker, as well as a degree of movement that the object associated with the candidate sleeping tracker exhibited. When the duration of the candidate sleeping tracker was too short, or the movement to small, the maturity test determines that the candidate sleeping tracker should not become a sleeping tracker. In various implementations, the techniques and systems described herein (e.g., adding a maturity test and/or relevant tracker test to a sleeping object detection system) can reduce false positive detection of sleeping trackers, and can improve the overall tracking results.

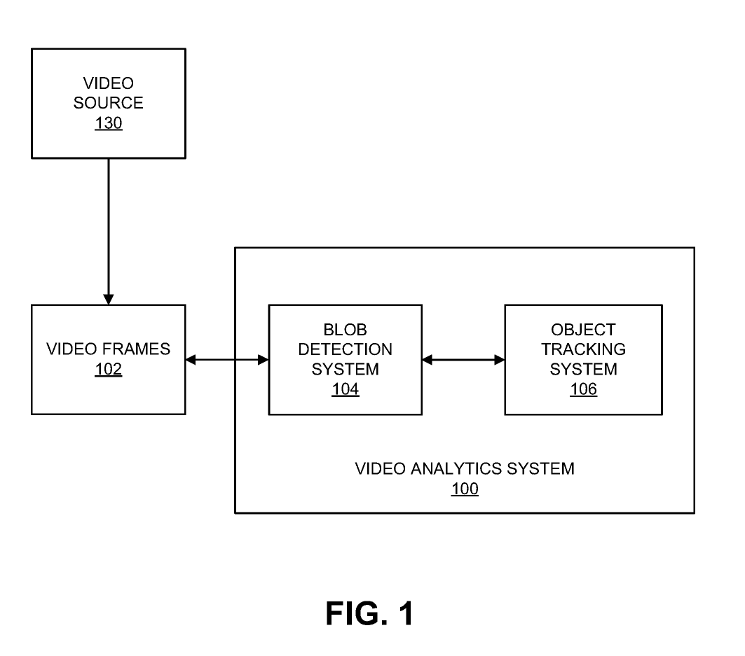

FIG. 1 is a block diagram illustrating an example of a video analytics system 100. The video analytics system 100 receives video frames 102 from a video source 130. The video frames 102 can also be referred to herein as a video picture or a picture. The video frames 102 can be part of one or more video sequences. The video source 130 can include a video capture device (e.g., a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 130 can include an IP camera or multiple IP cameras. In an illustrative example, multiple IP cameras can be located throughout an environment, and can provide the video frames 102 to the video analytics system 100. For instance, the IP cameras can be placed at various fields of view within the environment so that surveillance can be performed based on the captured video frames 102 of the environment.

In some embodiments, the video analytics system 100 and the video source 130 can be part of the same computing device. In some embodiments, the video analytics system 100 and the video source 130 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The video analytics system 100 includes a blob detection system 104 and an object tracking system 106. Object detection and tracking allows the video analytics system 100 to provide various end-to-end features, such as the video analytics features described above. For example, intelligent motion detection, intrusion detection, and other features can directly use the results from object detection and tracking to generate end-to-end events. Other features, such as people, vehicle, or other object counting and classification can be greatly simplified based on the results of object detection and tracking. The blob detection system 104 can detect one or more blobs in video frames (e.g., video frames 102) of a video sequence, and the object tracking system 106 can track the one or more blobs across the frames of the video sequence. As used herein, a blob refers to foreground pixels of at least a portion of an object (e.g., a portion of an object or an entire object) in a video frame. For example, a blob can include a contiguous group of pixels making up at least a portion of a foreground object in a video frame. In another example, a blob can refer to a contiguous group of pixels making up at least a portion of a background object in a frame of image data. A blob can also be referred to as an object, a portion of an object, a blotch of pixels, a pixel patch, a cluster of pixels, a blot of pixels, a spot of pixels, a mass of pixels, or any other term referring to a group of pixels of an object or portion thereof. In some examples, a bounding box can be associated with a blob. In some examples, a tracker can also be represented by a tracker bounding region. A bounding region of a blob or tracker can include a bounding box, a bounding circle, a bounding ellipse, or any other suitably-shaped region representing a tracker and/or blob. While examples are described herein using bounding boxes for illustrative purposes, the techniques and systems described herein can also apply using other suitably shaped bounding regions. A bounding box associated with a tracker and/or a blob can have a rectangular shape, a square shape, or other suitable shape. In the tracking layer, in case there is no need to know how the blob is formulated within a bounding box, the term blob and bounding box may be used interchangeably.

As described in more detail below, blobs can be tracked using blob trackers. A blob tracker can be associated with a tracker bounding box and can be assigned a tracker identifier (ID). In some examples, a bounding box for a blob tracker in a current frame can be the bounding box of a previous blob in a previous frame for which the blob tracker was associated. For instance, when the blob tracker is updated in the previous frame (after being associated with the previous blob in the previous frame), updated information for the blob tracker can include the tracking information for the previous frame and also prediction of a location of the blob tracker in the next frame (which is the current frame in this example). The prediction of the location of the blob tracker in the current frame can be based on the location of the blob in the previous frame. A history or motion model can be maintained for a blob tracker, including a history of various states, a history of the velocity, and a history of location, of continuous frames, for the blob tracker, as described in more detail below.

In some examples, a motion model for a blob tracker can determine and maintain two locations of the blob tracker for each frame. For example, a first location for a blob tracker for a current frame can include a predicted location in the current frame. The first location is referred to herein as the predicted location. The predicted location of the blob tracker in the current frame includes a location in a previous frame of a blob with which the blob tracker was associated. Hence, the location of the blob associated with the blob tracker in the previous frame can be used as the predicted location of the blob tracker in the current frame. A second location for the blob tracker for the current frame can include a location in the current frame of a blob with which the tracker is associated in the current frame. The second location is referred to herein as the actual location. Accordingly, the location in the current frame of a blob associated with the blob tracker is used as the actual location of the blob tracker in the current frame. The actual location of the blob tracker in the current frame can be used as the predicted location of the blob tracker in a next frame. The location of the blobs can include the locations of the bounding boxes of the blobs.

The velocity of a blob tracker can include the displacement of a blob tracker between consecutive frames. For example, the displacement can be determined between the centers (or centroids) of two bounding boxes for the blob tracker in two consecutive frames. In one illustrative example, the velocity of a blob tracker can be defined as Vₜ=Cₜ−Cₜ₋₁, where Cₜ−Cₜ₋₁=(Cₜₓ−Cₜ₋₁ₓ, C_{ty}−C_{t-1y}). The term Cₜ(Cₜₓ, C_{ty}) denotes the center position of a bounding box of the tracker in a current frame, with Cₜₓ being the x-coordinate of the bounding box, and C_{ty} being the y-coordinate of the bounding box. The term Cₜ₋₁(Cₜ₋₁ₓ, C_{t-1y}) denotes the center position (x and y) of a bounding box of the tracker in a previous frame. In some implementations, it is also possible to use four parameters to estimate x, y, width, height at the same time. In some cases, because the timing for video frame data is constant or at least not dramatically different overtime (according to the frame rate, such as 30 frames per second, 60 frames per second, 120 frames per second, or other suitable frame rate), a time variable may not be needed in the velocity calculation. In some cases, a time constant can be used (according to the instant frame rate) and/or a timestamp can be used.

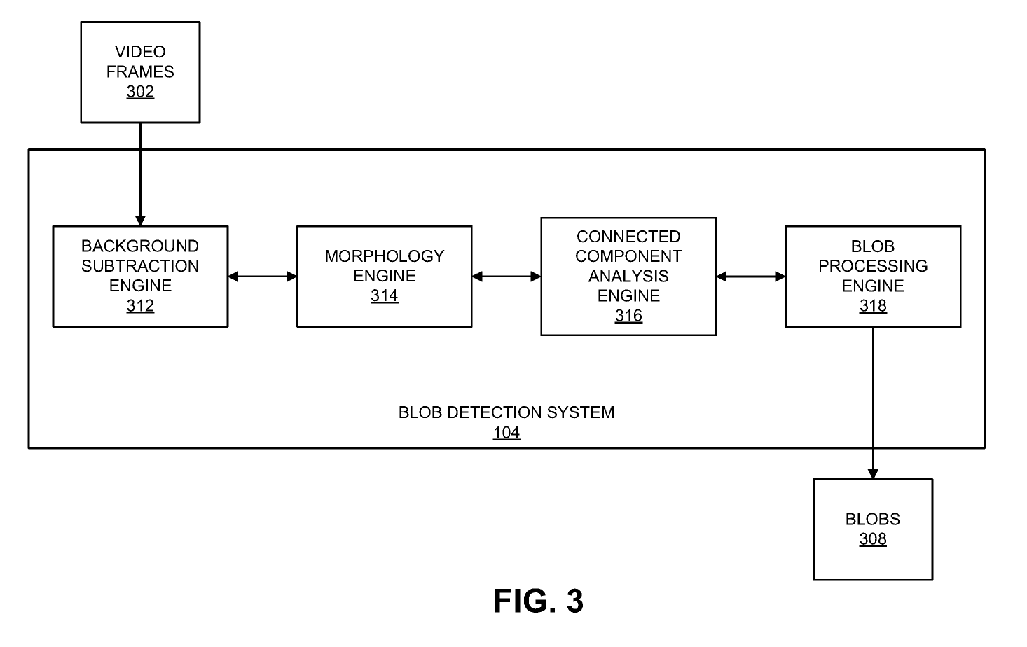

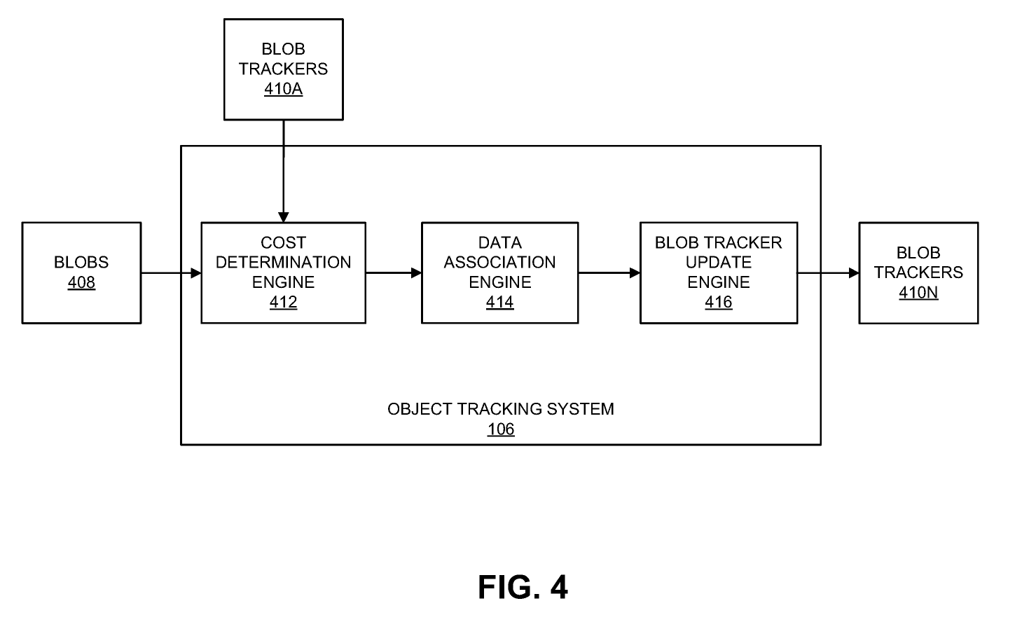

Using the blob detection system 104 and the object tracking system 106, the video analytics system 100 can perform blob generation and detection for each frame or picture of a video sequence. For example, the blob detection system 104 can perform background subtraction for a frame, and can then detect foreground pixels in the frame. Foreground blobs are generated from the foreground pixels using morphology operations and spatial analysis. Further, blob trackers from previous frames need to be associated with the foreground blobs in a current frame, and also need to be updated. Both the data association of trackers with blobs and tracker updates can rely on a cost function calculation. For example, when blobs are detected from a current input video frame, the blob trackers from the previous frame can be associated with the detected blobs according to a cost calculation. Trackers are then updated according to the data association, including updating the state and location of the trackers so that tracking of objects in the current frame can be fulfilled. Further details related to the blob detection system 104 and the object tracking system 106 are described with respect to FIGS. 3-4.

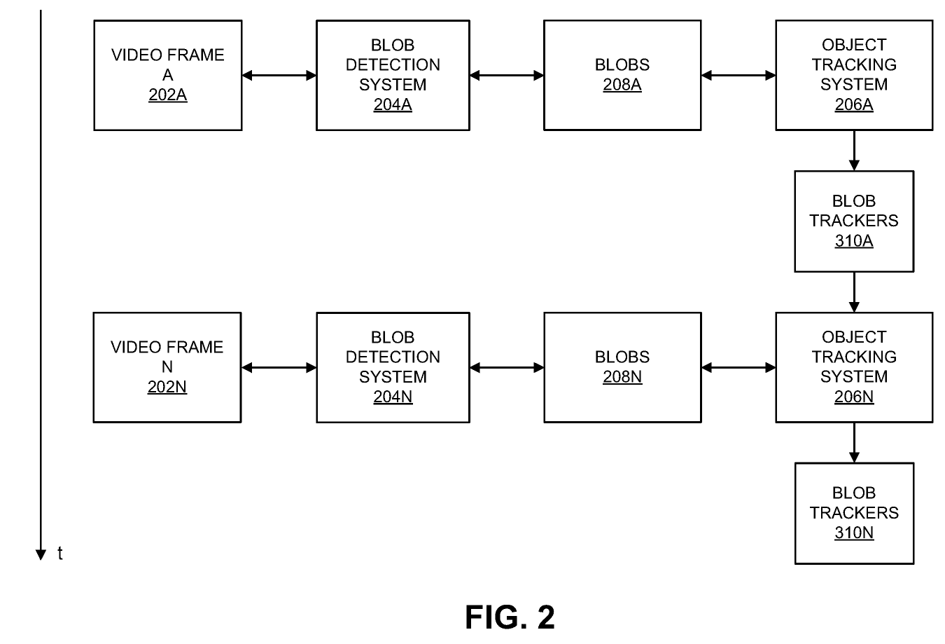

FIG. 2 is an example of the video analytics system (e.g., video analytics system 100) processing video frames across time t. As shown in FIG. 2, a video frame A 202A is received by a blob detection system 204A. The blob detection system 204A generates foreground blobs 208A for the current frame A 202A. After blob detection is performed, the foreground blobs 208A can be used for temporal tracking by the object tracking system 206A. Costs (e.g., a cost including a distance, a weighted distance, or other cost) between blob trackers and blobs can be calculated by the object tracking system 206A. The object tracking system 206A can perform data association to associate or match the blob trackers (e.g., blob trackers generated or updated based on a previous frame or newly generated blob trackers) and blobs 208A using the calculated costs (e.g., using a cost matrix or other suitable association technique). The blob trackers can be updated, including in terms of positions of the trackers, according to the data association to generate updated blob trackers 310A. For example, a blob tracker's state and location for the video frame A 202A can be calculated and updated. The blob tracker's location in a next video frame N 202N can also be predicted from the current video frame A 202A. For example, the predicted location of a blob tracker for the next video frame N 202N can include the location of the blob tracker (and its associated blob) in the current video frame A 202A. Tracking of blobs of the current frame A 202A can be performed once the updated blob trackers 310A are generated.

When a next video frame N 202N is received, the blob detection system 204N generates foreground blobs 208N for the frame N 202N. The object tracking system 206N can then perform temporal tracking of the blobs 208N. For example, the object tracking system 206N obtains the blob trackers 310A that were updated based on the prior video frame A 202A. The object tracking system 206N can then calculate a cost and can associate the blob trackers 310A and the blobs 208N using the newly calculated cost. The blob trackers 310A can be updated according to the data association to generate updated blob trackers 310N.

FIG. 3 is a block diagram illustrating an example of a blob detection system 104. Blob detection is used to segment moving objects from the global background in a scene. The blob detection system 104 includes a background subtraction engine 312 that receives video frames 302. The background subtraction engine 312 can perform background subtraction to detect foreground pixels in one or more of the video frames 302. For example, the background subtraction can be used to segment moving objects from the global background in a video sequence and to generate a foreground-background binary mask (referred to herein as a foreground mask). In some examples, the background subtraction can perform a subtraction between a current frame or picture and a background model including the background part of a scene (e.g., the static or mostly static part of the scene). Based on the results of background subtraction, the morphology engine 314 and connected component analysis engine 316 can perform foreground pixel processing to group the foreground pixels into foreground blobs for tracking purpose. For example, after background subtraction, morphology operations can be applied to remove noisy pixels as well as to smooth the foreground mask. Connected component analysis can then be applied to generate the blobs. Blob processing can then be performed, which may include further filtering out some blobs and merging together some blobs to provide bounding boxes as input for tracking.

The background subtraction engine 312 can model the background of a scene (e.g., captured in the video sequence) using any suitable background subtraction technique (also referred to as background extraction). One example of a background subtraction method used by the background subtraction engine 312 includes modeling the background of the scene as a statistical model based on the relatively static pixels in previous frames which are not considered to belong to any moving region. For example, the background subtraction engine 312 can use a Gaussian distribution model for each pixel location, with parameters of mean and variance to model each pixel location in frames of a video sequence. All the values of previous pixels at a particular pixel location are used to calculate the mean and variance of the target Gaussian model for the pixel location. When a pixel at a given location in a new video frame is processed, its value will be evaluated by the current Gaussian distribution of this pixel location. A classification of the pixel to either a foreground pixel or a background pixel is done by comparing the difference between the pixel value and the mean of the designated Gaussian model. In one illustrative example, if the distance of the pixel value and the Gaussian Mean is less than 3 times of the variance, the pixel is classified as a background pixel. Otherwise, in this illustrative example, the pixel is classified as a foreground pixel. At the same time, the Gaussian model for a pixel location will be updated by taking into consideration the current pixel value.

The background subtraction engine 312 can also perform background subtraction using a mixture of Gaussians (also referred to as a Gaussian mixture model (GMM)). A GMM models each pixel as a mixture of Gaussians and uses an online learning algorithm to update the model. Each Gaussian model is represented with mean, standard deviation (or covariance matrix if the pixel has multiple channels), and weight. Weight represents the probability that the Gaussian occurs in the past history.

P(Xₜ)=Σᵢ₌₁^{K} ω_{i,t}N(Xₜ|μ_{i,t}, Σ_{i,t}) Equation (10)

An equation of the GMM model is shown in equation (1), wherein there are K Gaussian models. Each Guassian model has a distribution with a mean of μ and variance of Σ, and has a weight ω. Here, i is the index to the Gaussian model and t is the time instance. As shown by the equation, the parameters of the GMM change over time after one frame (at time t) is processed. In GMM or any other learning based background subtraction, the current pixel impacts the whole model of the pixel location based on a learning rate, which could be constant or typically at least the same for each pixel location. A background subtraction method based on GMM (or other learning based background subtraction) adapts to local changes for each pixel. Thus, once a moving object stops, for each pixel location of the object, the same pixel value keeps on contributing to its associated background model heavily, and the region associated with the object becomes background.

The background subtraction techniques mentioned above are based on the assumption that the camera is mounted still, and if anytime the camera is moved or orientation of the camera is changed, a new background model will need to be calculated. There are also background subtraction methods that can handle foreground subtraction based on a moving background, including techniques such as tracking key points, optical flow, saliency, and other motion estimation based approaches.

The background subtraction engine 312 can generate a foreground mask with foreground pixels based on the result of background subtraction. For example, the foreground mask can include a binary image containing the pixels making up the foreground objects (e.g., moving objects) in a scene and the pixels of the background. In some examples, the background of the foreground mask (background pixels) can be a solid color, such as a solid white background, a solid black background, or other solid color. In such examples, the foreground pixels of the foreground mask can be a different color than that used for the background pixels, such as a solid black color, a solid white color, or other solid color. In one illustrative example, the background pixels can be black (e.g., pixel color value 0 in 8-bit grayscale or other suitable value) and the foreground pixels can be white (e.g., pixel color value 255 in 8-bit grayscale or other suitable value). In another illustrative example, the background pixels can be white and the foreground pixels can be black.

Using the foreground mask generated from background subtraction, a morphology engine 314 can perform morphology functions to filter the foreground pixels. The morphology functions can include erosion and dilation functions. In one example, an erosion function can be applied, followed by a series of one or more dilation functions. An erosion function can be applied to remove pixels on object boundaries. For example, the morphology engine 314 can apply an erosion function (e.g., FilterErode3×3) to a 3×3 filter window of a center pixel, which is currently being processed. The 3×3 window can be applied to each foreground pixel (as the center pixel) in the foreground mask. One of ordinary skill in the art will appreciate that other window sizes can be used other than a 3×3 window. The erosion function can include an erosion operation that sets a current foreground pixel in the foreground mask (acting as the center pixel) to a background pixel if one or more of its neighboring pixels within the 3×3 window are background pixels. Such an erosion operation can be referred to as a strong erosion operation or a single-neighbor erosion operation. Here, the neighboring pixels of the current center pixel include the eight pixels in the 3×3 window, with the ninth pixel being the current center pixel.

A dilation operation can be used to enhance the boundary of a foreground object. For example, the morphology engine 314 can apply a dilation function (e.g., FilterDilate3×3) to a 3×3 filter window of a center pixel. The 3×3 dilation window can be applied to each background pixel (as the center pixel) in the foreground mask. One of ordinary skill in the art will appreciate that other window sizes can be used other than a 3×3 window. The dilation function can include a dilation operation that sets a current background pixel in the foreground mask (acting as the center pixel) as a foreground pixel if one or more of its neighboring pixels in the 3×3 window are foreground pixels. The neighboring pixels of the current center pixel include the eight pixels in the 3×3 window, with the ninth pixel being the current center pixel. In some examples, multiple dilation functions can be applied after an erosion function is applied. In one illustrative example, three function calls of dilation of 3×3 window size can be applied to the foreground mask before it is sent to the connected component analysis engine 316. In some examples, an erosion function can be applied first to remove noise pixels, and a series of dilation functions can then be applied to refine the foreground pixels. In one illustrative example, one erosion function with a 3×3 window size is called first, and three function calls of dilation of the 3×3 window size are applied to the foreground mask before it is sent to the connected component analysis engine 316. Details regarding content-adaptive morphology operations are described below.

After the morphology operations are performed, the connected component analysis engine 316 can apply connected component analysis to connect neighboring foreground pixels to formulate connected components and blobs. In some implementation of connected component analysis, a set of bounding boxes are returned in a way that each bounding box contains one component of connected pixels. One example of the connected component analysis performed by the connected component analysis engine 316 is implemented as follows:

```
    for each pixel of the foreground mask {
        -if it is a foreground pixel and has not been processed, the
        following steps apply:
          -Apply FloodFill function to connect this pixel to other
foreground and generate a connected component
          -Insert the connected component in a list of connected
          components.
          -Mark the pixels in the connected component as being
          processed. }
```

The Floodfill (seed fill) function is an algorithm that determines the area connected to a seed node in a multi-dimensional array (e.g., a 2-D image in this case). This Floodfill function first obtains the color or intensity value at the seed position (e.g., a foreground pixel) of the source foreground mask, and then finds all the neighbor pixels that have the same (or similar) value based on 4 or 8 connectivity. For example, in a 4 connectivity case, a current pixel's neighbors are defined as those with a coordination being (x+d, y) or (x, y+d), wherein d is equal to 1 or −1 and (x, y) is the current pixel. One of ordinary skill in the art will appreciate that other amounts of connectivity can be used. Some objects are separated into different connected components and some objects are grouped into the same connected components (e.g., neighbor pixels with the same or similar values). Additional processing may be applied to further process the connected components for grouping. Finally, the blobs 308 are generated that include neighboring foreground pixels according to the connected components. In one example, a blob can be made up of one connected component. In another example, a blob can include multiple connected components (e.g., when two or more blobs are merged together).

The blob processing engine 318 can perform additional processing to further process the blobs generated by the connected component analysis engine 316. In some examples, the blob processing engine 318 can generate the bounding boxes to represent the detected blobs and blob trackers. In some cases, the blob bounding boxes can be output from the blob detection system 104. In some examples, there may be a filtering process for the connected components (bounding boxes). For instance, the blob processing engine 318 can perform content-based filtering of certain blobs. In some cases, a machine learning method can determine that a current blob contains noise (e.g., foliage in a scene). Using the machine learning information, the blob processing engine 318 can determine the current blob is a noisy blob and can remove it from the resulting blobs that are provided to the object tracking system 106. In some cases, the blob processing engine 318 can filter out one or more small blobs that are below a certain size threshold (e.g., an area of a bounding box surrounding a blob is below an area threshold). In some examples, there may be a merging process to merge some connected components (represented as bounding boxes) into bigger bounding boxes. For instance, the blob processing engine 318 can merge close blobs into one big blob to remove the risk of having too many small blobs that could belong to one object. In some cases, two or more bounding boxes may be merged together based on certain rules even when the foreground pixels of the two bounding boxes are totally disconnected. In some embodiments, the blob detection engine 104 does not include the blob processing engine 318, or does not use the blob processing engine 318 in some instances. For example, the blobs generated by the connected component analysis engine 316, without further processing, can be input to the object tracking system 106 to perform blob and/or object tracking.

In some implementations, density based blob area trimming may be performed by the blob processing engine 318. For example, when all blobs have been formulated after post-filtering and before the blobs are input into the tracking layer, the density based blob area trimming can be applied. A similar process is applied vertically and horizontally. For example, the density based blob area trimming can first be performed vertically and then horizontally, or vice versa. The purpose of density based blob area trimming is to filter out the columns (in the vertical process) and/or the rows (in the horizontal process) of a bounding box if the columns or rows only contain a small number of foreground pixels.

The vertical process includes calculating the number of foreground pixels of each column of a bounding box, and denoting the number of foreground pixels as the column density. Then, from the left-most column, columns are processed one by one. The column density of each current column (the column currently being processed) is compared with the maximum column density (the column density of all columns). If the column density of the current column is smaller than a threshold (e.g., a percentage of the maximum column density, such as 10%, 20%, 30%, 50%, or other suitable percentage), the column is removed from the bounding box and the next column is processed. However, once a current column has a column density that is not smaller than the threshold, such a process terminates and the remaining columns are not processed anymore. A similar process can then be applied from the right-most column. One of ordinary skill will appreciate that the vertical process can process the columns beginning with a different column than the left-most column, such as the right-most column or other suitable column in the bounding box.

The horizontal density based blob area trimming process is similar to the vertical process, except the rows of a bounding box are processed instead of columns. For example, the number of foreground pixels of each row of a bounding box is calculated, and is denoted as row density. From the top-most row, the rows are then processed one by one. For each current row (the row currently being processed), the row density is compared with the maximum row density (the row density of all the rows). If the row density of the current row is smaller than a threshold (e.g., a percentage of the maximum row density, such as 10%, 20%, 30%, 50%, or other suitable percentage), the row is removed from the bounding box and the next row is processed. However, once a current row has a row density that is not smaller than the threshold, such a process terminates and the remaining rows are not processed anymore. A similar process can then be applied from the bottom-most row. One of ordinary skill will appreciate that the horizontal process can process the rows beginning with a different row than the top-most row, such as the bottom-most row or other suitable row in the bounding box.

One purpose of the density based blob area trimming is for shadow removal. For example, the density based blob area trimming can be applied when one person is detected together with his or her long and thin shadow in one blob (bounding box). Such a shadow area can be removed after applying density based blob area trimming, since the column density in the shadow area is relatively small. Unlike morphology, which changes the thickness of a blob (besides filtering some isolated foreground pixels from formulating blobs) but roughly preserves the shape of a bounding box, such a density based blob area trimming method can dramatically change the shape of a bounding box.

Once the blobs are detected and processed, object tracking (also referred to as blob tracking) can be performed to track the detected blobs. FIG. 4 is a block diagram illustrating an example of an object tracking system 106. The input to the blob/object tracking is a list of the blobs 408 (e.g., the bounding boxes of the blobs) generated by the blob detection engine 104. In some cases, a tracker is assigned with a unique ID, and a history of bounding boxes is kept. Object tracking in a video sequence can be used for many applications, including surveillance applications, among many others. For example, the ability to detect and track multiple objects in the same scene is of great interest in many security applications. When blobs (making up at least portions of objects) are detected from an input video frame, blob trackers from the previous video frame need to be associated to the blobs in the input video frame according to a cost calculation. The blob trackers can be updated based on the associated foreground blobs. In some instances, the steps in object tracking can be conducted in a series manner.

A cost determination engine 412 of the object tracking system 106 can obtain the blobs 408 of a current video frame from the blob detection system 104. The cost determination engine 412 can also obtain the blob trackers 410A updated from the previous video frame (e.g., video frame A 202A). A cost function can then be used to calculate costs between the blob trackers 410A and the blobs 408. Any suitable cost function can be used to calculate the costs. In some examples, the cost determination engine 412 can measure the cost between a blob tracker and a blob by calculating the Euclidean distance between the centroid of the tracker (e.g., the bounding box for the tracker) and the centroid of the bounding box of the foreground blob. In one illustrative example using a 2-D video sequence, this type of cost function is calculated as below:

Cost_{tb}=\sqrt{(tₓ−bₓ)²+(t_{y}−b₂)²}

The terms (tₓ, t_{y}) and (bₓ, b_{y}) are the center locations of the blob tracker and blob bounding boxes, respectively. As noted herein, in some examples, the bounding box of the blob tracker can be the bounding box of a blob associated with the blob tracker in a previous frame. In some examples, other cost function approaches can be performed that use a minimum distance in an x-direction or y-direction to calculate the cost. Such techniques can be good for certain controlled scenarios, such as well-aligned lane conveying. In some examples, a cost function can be based on a distance of a blob tracker and a blob, where instead of using the center position of the bounding boxes of blob and tracker to calculate distance, the boundaries of the bounding boxes are considered so that a negative distance is introduced when two bounding boxes are overlapped geometrically. In addition, the value of such a distance is further adjusted according to the size ratio of the two associated bounding boxes. For example, a cost can be weighted based on a ratio between the area of the blob tracker bounding box and the area of the blob bounding box (e.g., by multiplying the determined distance by the ratio).

In some embodiments, a cost is determined for each tracker-blob pair between each tracker and each blob. For example, if there are three trackers, including tracker A, tracker B, and tracker C, and three blobs, including blob A, blob B, and blob C, a separate cost between tracker A and each of the blobs A, B, and C can be determined, as well as separate costs between trackers B and C and each of the blobs A, B, and C. In some examples, the costs can be arranged in a cost matrix, which can be used for data association. For example, the cost matrix can be a 2-dimensional matrix, with one dimension being the blob trackers 410A and the second dimension being the blobs 408. Every tracker-blob pair or combination between the trackers 410A and the blobs 408 includes a cost that is included in the cost matrix. Best matches between the trackers 410A and blobs 408 can be determined by identifying the lowest cost tracker-blob pairs in the matrix. For example, the lowest cost between tracker A and the blobs A, B, and C is used to determine the blob with which to associate the tracker A.

Data association between trackers 410A and blobs 408, as well as updating of the trackers 410A, may be based on the determined costs. The data association engine 414 matches or assigns a tracker (or tracker bounding box) with a corresponding blob (or blob bounding box) and vice versa. For example, as described previously, the lowest cost tracker-blob pairs may be used by the data association engine 414 to associate the blob trackers 410A with the blobs 408. Another technique for associating blob trackers with blobs includes the Hungarian method, which is a combinatorial optimization algorithm that solves such an assignment problem in polynomial time and that anticipated later primal-dual methods. For example, the Hungarian method can optimize a global cost across all blob trackers 410A with the blobs 408 in order to minimize the global cost. The blob tracker-blob combinations in the cost matrix that minimize the global cost can be determined and used as the association.

In addition to the Hungarian method, other robust methods can be used to perform data association between blobs and blob trackers. For example, the association problem can be solved with additional constraints to make the solution more robust to noise while matching as many trackers and blobs as possible. Regardless of the association technique that is used, the data association engine 414 can rely on the distance between the blobs and trackers.

Once the association between the blob trackers 410A and blobs 408 has been completed, the blob tracker update engine 416 can use the information of the associated blobs, as well as the trackers' temporal statuses, to update the status (or states) of the trackers 410A for the current frame. Upon updating the trackers 410A, the blob tracker update engine 416 can perform object tracking using the updated trackers 410N, and can also provide the updated trackers 410N for use in processing a next frame.

The status or state of a blob tracker can include the tracker's identified location (or actual location) in a current frame and its predicted location in the next frame. The location of the foreground blobs are identified by the blob detection engine 104. However, as described in more detail below, the location of a blob tracker in a current frame may need to be predicted based on information from a previous frame (e.g., using a location of a blob associated with the blob tracker in the previous frame). After the data association is performed for the current frame, the tracker location in the current frame can be identified as the location of its associated blob(s) in the current frame. The tracker's location can be further used to update the tracker's motion model and predict its location in the next frame. Further, in some cases, there may be trackers that are temporarily lost (e.g., when a blob the tracker was tracking is no longer detected), in which case the locations of such trackers also need to be predicted (e.g., by a Kalman filter). Such trackers are temporarily not shown to the system. Prediction of the bounding box location helps not only to maintain certain level of tracking for lost and/or merged bounding boxes, but also to give more accurate estimation of the initial position of the trackers so that the association of the bounding boxes and trackers can be made more precise.

As noted above, the location of a blob tracker in a current frame may be predicted based on information from a previous frame One method for performing a tracker location update is using a Kalman filter. The Kalman filter is a framework that includes two steps. The first step is to predict a tracker's state, and the second step is to use measurements to correct or update the state. In this case, the tracker from the last frame predicts (using the blob tracker update engine 416) its location in the current frame, and when the current frame is received, the tracker first uses the measurement of the blob(s) (e.g., the blob(s) bounding box(es)) to correct its location states and then predicts its location in the next frame. For example, a blob tracker can employ a Kalman filter to measure its trajectory as well as predict its future location(s). The Kalman filter relies on the measurement of the associated blob(s) to correct the motion model for the blob tracker and to predict the location of the object tracker in the next frame. In some examples, if a blob tracker is associated with a blob in a current frame, the location of the blob is directly used to correct the blob tracker's motion model in the Kalman filter. In some examples, if a blob tracker is not associated with any blob in a current frame, the blob tracker's location in the current frame is identified as its predicted location from the previous frame, meaning that the motion model for the blob tracker is not corrected and the prediction propagates with the blob tracker's last model (from the previous frame).

Other than the location of a tracker, the state or status of a tracker can also, or alternatively, include a tracker's temporal state or status. The temporal state of a tracker can include a new state indicating the tracker is a new tracker that was not present before the current frame, a normal state for a tracker that has been alive for a certain duration and that is to be output as an identified tracker-blob pair to the video analytics system, a lost state for a tracker that is not associated or matched with any foreground blob in the current frame, a dead state for a tracker that fails to associate with any blobs for a certain number of consecutive frames (e.g., two or more frames, a threshold duration, or the like), and/or other suitable temporal status. Another temporal state that can be maintained for a blob tracker is a duration of the tracker. The duration of a blob tracker includes the number of frames (or other temporal measurement, such as time) the tracker has been associated with one or more blobs.

There may be other state or status information needed for updating the tracker, which may require a state machine for object tracking. Given the information of the associated blob(s) and the tracker's own status history table, the status also needs to be updated. The state machine collects all the necessary information and updates the status accordingly. Various statuses of trackers can be updated. For example, other than a tracker's life status (e.g., new, lost, dead, or other suitable life status), the tracker's association confidence and relationship with other trackers can also be updated. Taking one example of the tracker relationship, when two objects (e.g., persons, vehicles, or other objects of interest) intersect, the two trackers associated with the two objects will be merged together for certain frames, and the merge or occlusion status needs to be recorded for high level video analytics.

Regardless of the tracking method being used, a new tracker starts to be associated with a blob in one frame and, moving forward, the new tracker may be connected with possibly moving blobs across multiple frames. When a tracker has been continuously associated with blobs and a duration (a threshold duration) has passed, the tracker may be promoted to be a normal tracker. A normal tracker is output as an identified tracker-blob pair. For example, a tracker-blob pair is output at the system level as an event (e.g., presented as a tracked object on a display, output as an alert, and/or other suitable event) when the tracker is promoted to be a normal tracker. In some implementations, a normal tracker (e.g., including certain status data of the normal tracker, the motion model for the normal tracker, or other information related to the normal tracker) can be output as part of object metadata. The metadata, including the normal tracker, can be output from the video analytics system (e.g., an IP camera running the video analytics system) to a server or other system storage. The metadata can then be analyzed for event detection (e.g., by rule interpreter). A tracker that is not promoted as a normal tracker can be removed (or killed), after which the tracker can be considered as dead.

As noted above, blob trackers can have various temporal states, such as a new state for a tracker of a current frame that was not present before the current frame, a lost state for a tracker that is not associated or matched with any foreground blob in the current frame, a dead state for a tracker that fails to associate with any blobs for a certain number of consecutive frames (e.g., 2 or more frames, a threshold duration, or the like), a normal state for a tracker that is to be output as an identified tracker-blob pair to the video analytics system, or other suitable tracker states. Another temporal state that can be maintained for a blob tracker is a duration of the tracker. The duration of a blob tracker includes the number of frames (or other temporal measurement, such as time) the tracker has been associated with one or more blobs.

A blob tracker can be promoted or converted to be a normal tracker when certain conditions are met. A tracker is given a new state when the tracker is created and its duration of being associated with any blobs is 0. The duration of the blob tracker can be monitored, as well as its temporal state (new, lost, hidden, or the like). As long as the current state is not hidden or lost, and as long as the duration is less than a threshold duration T1, the state of the new tracker is kept as a new state. A hidden tracker may refer to a tracker that was previously normal (thus independent), but later merged into another tracker C. In order to enable this hidden tracker to be identified later due to the anticipation that the merged object may be split later, it is still kept as associated with the other tracker C which is containing it.

The threshold duration T1 is a duration that a new blob tracker must be continuously associated with one or more blobs before it is converted to a normal tracker (transitioned to a normal state). The threshold duration can be a number of frames (e.g., at least N frames) or an amount of time. In one illustrative example, a blob tracker can be in a new state for 30 frames (corresponding to one second in systems that operate using 30 frames per second), or any other suitable number of frames or amount of time, before being converted to a normal tracker. If the blob tracker has been continuously associated with blobs for the threshold duration (duration≥T1), the blob tracker is converted to a normal tracker by being transitioned from a new status to a normal status.

If, during the threshold duration T1, the new tracker becomes hidden or lost (e.g., not associated or matched with any foreground blob), the state of the tracker can be transitioned from new to dead, and the blob tracker can be removed from blob trackers maintained for a video sequence (e.g., removed from a buffer that stores the trackers for the video sequence).

In some examples, objects may intersect or group together, in which case the blob detection system can detect one blob (a merged blob) that contains more than one object of interest (e.g., multiple objects that are being tracked). For example, as a person walks near another person in a scene, the bounding boxes for the two persons can become a merged bounding box (corresponding to a merged blob). The merged bounding box can be tracked with a single blob tracker (referred to as a container tracker), which can include one of the blob trackers that was associated with one of the blobs making up the merged blob, with the other blob(s)' trackers being referred to as merge-contained trackers. For example, a merge-contained tracker is a tracker (new or normal) that was merged with another tracker when two blobs for the respective trackers are merged, and thus became hidden and carried by the container tracker.

A tracker that is split from an existing tracker is referred to as a split-new tracker. The tracker from which the split-new tracker is split is referred to as a parent tracker or a split-from tracker. In some examples, a split-new tracker can result from the association (or matching or mapping) of multiple blobs to one active tracker. For instance, one active tracker can only be mapped to one blob. All the other blobs (the blobs remaining from the multiple blobs that are not mapped to the tracker) cannot be mapped to any existing trackers. In such examples, new trackers will be created for the other blobs, and these new trackers are assigned the state “split-new.” Such a split-new tracker can be referred to as the child tracker of the original tracker its associated blob is mapped to. The corresponding original tracker can be referred to as the parent tracker (or the split-from tracker) of the child tracker. In some examples, a split-new tracker can also result from a merge-contained tracker. As noted above, a merge-contained tracker is a tracker that was merged with another tracker (when two blobs for the respective trackers are merged) and thus became hidden and carried by the container tracker. A merge-contained tracker can be split from the container tracker if the container tracker is active and the container tracker has a mapped blob in the current frame.

As previously described, the threshold duration T1 is a duration that a new blob tracker must be continuously associated with one or more blobs before it is converted to a normal tracker. A threshold duration T2 is a duration a split-new tracker must be continuously associated with one or more blobs before it is converted to a normal tracker. In some examples, the threshold duration T2 used for split-new trackers can be the same as the threshold duration T1 used for new trackers (e.g., 20 frames, 30 frames, 32 frames, 60 frames, 1 second, 2 seconds, or other suitable duration or number of frames). In other examples, the threshold duration T2 for split-new trackers can be a shorter duration than the threshold duration T1 used for new trackers. For example, T2 can be set to a smaller value than T1. In some implementations, the duration T2 can be proportional to T1. In one illustrative example, T1 may indicate one second of duration, and thus is equal to the (average) frame rate of the input video (e.g., 30 frames at 30 frames per second, 60 frames at 60 frames per second, or other suitable duration and frame rate). In such an example, the duration T2 can be set to half of T1.

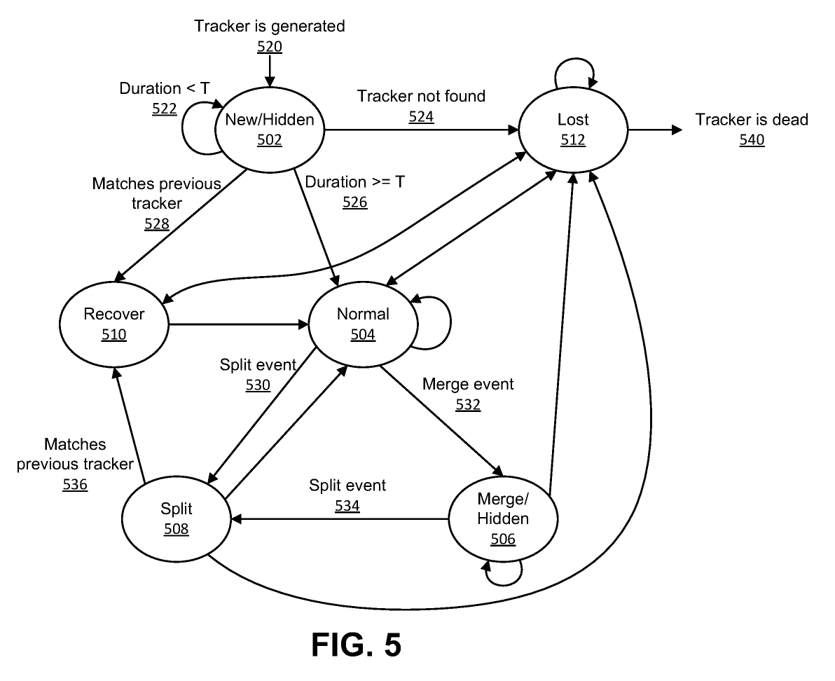

FIG. 5 illustrates an example of states that a tracker can undergo through the course of a tracker's existence. In many cases, a tracker may experience fewer than all of the example states. In various implementations, a tracker may experience additional states that are not illustrated here. Each state transition, illustrated in this example with an arrow, can occur upon the receipt of data corresponding to a new input video frame.

At transition 520, a new tracker can be generated. The new tracker can have an initial state of New and/or Hidden 502. As discussed above, a new tracker can be generated when, for a given video frame, a blob is detected for which no tracker can be found. As also discussed above, new trackers may be “hidden,” meaning that the blob that corresponds to the tracker may not yet be tracked. Hidden new trackers may not be output from the system.

As illustrated by transition 522, a New/Hidden 502 tracker may remain New/Hidden 502 while a duration is less than a threshold, T. The duration may be counted as a number of frames, a number of milliseconds or seconds, or by some other measure of time. During the duration, the system may not yet have sufficient data to confirm that a blob that corresponds to the New/Hidden 502 tracker is an object moving within the scene. For example, the blob may be visual noise or tree leaves moving in the wind, or some other pixels that should be classified as background pixels. Alternatively or additionally, the blob may be within the scene for only fractions of a second, and thus not be present long enough to be tracked.

In this and other examples, while the duration is less than T, the tracker may undergo transition 524, in which, for a current video frame, the tracker can no longer be matched to a blob. The tracker may then be considered Lost 512. Lost trackers are discussed further below.

Alternatively, when the duration is greater than or equal to T, the tracker may undergo transition 526, and become a Normal 504 tracker. In subsequent frames, the tracker may remain Normal 504, unless an event, such as a split event 530 or a merge event 532 occurs, or the tracker becomes Lost 512. As noted above, a tracker can become Lost 512 when the blob that corresponds to the tracker cannot be found in the current video frame.

Alternatively, a New/Hidden 502 tracker can become a Recover 510 tracker through transition 528, when the system determines that the tracker matches a previous tracker. This can occur, for example, when an object is stationary within the scene for long enough to be classified as background pixels, and thus becomes Lost 512, and then the object starts moving again. As another example, an object may move out of view (possibly becoming Lost 512) and then come back into view. In some implementations, the Recover 510 tracker inherits the data of the tracker that matched the Recover 510 tracker. In some implementations, and not illustrated here, the Recover 510 tracker may be deleted, and a Lost 512 tracker that matched the Recover 510 track may be transitioned to the Recover 510 state. A Recover 510 tracker can transition to Normal 504 in a subsequent video frame, or can transition to Lost 512.

As noted above, a merge event 532 can occur when to blobs are within a certain distance of each other within the scene, and thus are recognized by the system as one object. For example, two people may enter the scene from opposite directions, and walk together for a while. When a merge event 532 occurs, a normal 504 tracker may become a Merge/Hidden 506 tracker. A merge tracker can inherit the data from the trackers that have been merged together. In some implementations, one of the trackers may be considered a “parent” or “root” tracker, and all other trackers in the merge group can be considered “children” or “leaves.” In some implementations, the parent tracker continues to be tracked in subsequent frames, while the child trackers are hidden, meaning the child trackers may be updated along with the parent tracker, but the child trackers are not output by the system. In various implementations, a Merge/Hidden 506 tracker remains in this state unless a split event 534 occurs, or the Merge/Hidden 506 tracker becomes Lost 512.

When a split event 534 occurs, a blob that is associated with the tracker splits into two or more blobs, each of which can be assigned a different tracker by the system. A Normal 504 tracker can also undergo a split event 530, such as for example when two people walk together into the scene and are identified as one blob, and then later walk in two different directions and are identified as two different blobs. A Split 508 tracker can inherit the tracking data of the Normal 504 tracker, such that each tracker that is split from the Normal 504 tracker retains the tracking history of the Normal 504 tracker. In a subsequent frame, the Split 508 tracker may transition to Normal 504. This transition may occur, for example, after a duration has passed. A group of Split 508 trackers that resulted from one blob splitting into multiple blobs can be referred to as a split group.

When a Split 508 tracker splits from a Merge/Hidden 506 tracker, in some cases the Split 508 tracker may inherit the data from the Merge/Hidden 506 tracker, including the data from the parent tracker and any child trackers. Alternatively, in some implementations, the Split 508 tracker may be matched to the parent tracker or one of the child trackers, meaning that the system determines that the Split 508 tracker is for a blob that previously merged with another blob. When this occurs, the Split 508 tracker may undergo transition 536, and become a Recover 510 tracker.

As illustrated in the example of FIG. 5, a New/Hidden 502 tracker, a Recover 510 tracker, a Normal 504 tracker, a Merge/Hidden 506 tracker, or a Split 508 tracker can become Lost 512 before undergoing any other state transition. A tracker can become Lost 512 when, from a first video frame to a second video frame, a blob that was associated with the tracker in the first video frame cannot be found in the second video frame. The object represented by the blob may have moved out of view or may have become stationary, and have been included among background pixels. In some implementations, the system may maintain a tracker as Lost 512 for a period of time. During this period of time, the system may identify a blob that can be associated with the Lost 512 tracker, in which case the tracker may be transitioned to the Recover 510 state. In some implementations, a Lost 512 tracker, once associated with a blob, may transition directly to the Normal 504 state.

When a Lost 512 tracker remains lost for more than a pre-determined amount of time (e.g., ten frames, 5 or 10 milliseconds, or some other measure of time), the system may determine that the object that was being tracked is no longer in the scene. In such a case, at transition 540, the tracker may be considered dead. A dead tracker may be deleted from the tracking system.

As described above, blob detection can be performed for one or more video frames to generate or identify blobs representing one or more objects for the one or more video frames. The background subtraction component of the blob detection encounters issues when dealing with sleeping objects. A sleeping object is an object that is moving through a scene and that eventually becomes stationary, static, or moves too slowly to be detected as foreground. For example, a car can enter a scene by driving into a parking lot and then parking in a parking spot. Once the car parks, it can become a sleeping object. A blob and the object represented by the blob can be detected and tracked based on background subtraction, as long as the object is in motion. However, once the object pauses or stops and becomes a sleeping object, the background subtraction model will transition the pixels of the object from foreground pixels to background pixels due to the nature of background subtraction adapting to local changes quickly. For example, a background subtraction process based on a GMM or other statistical learning model adapts to the local changes for each pixel. Once a moving object stops or pauses, for each pixel location making up the object, the same pixel value (due to the pixel value for that location not changing) continues contributing to the associated background model, causing the region associated with the object to become background. Once the pixels making up the object are detected as background by the background subtraction process, the object and its blob vanish (or are absorbed) into the background and can no longer be detected as foreground and tracked. A sleeping object thus will not be detected and tracking of the object will be lost for a simple background subtraction based solution.

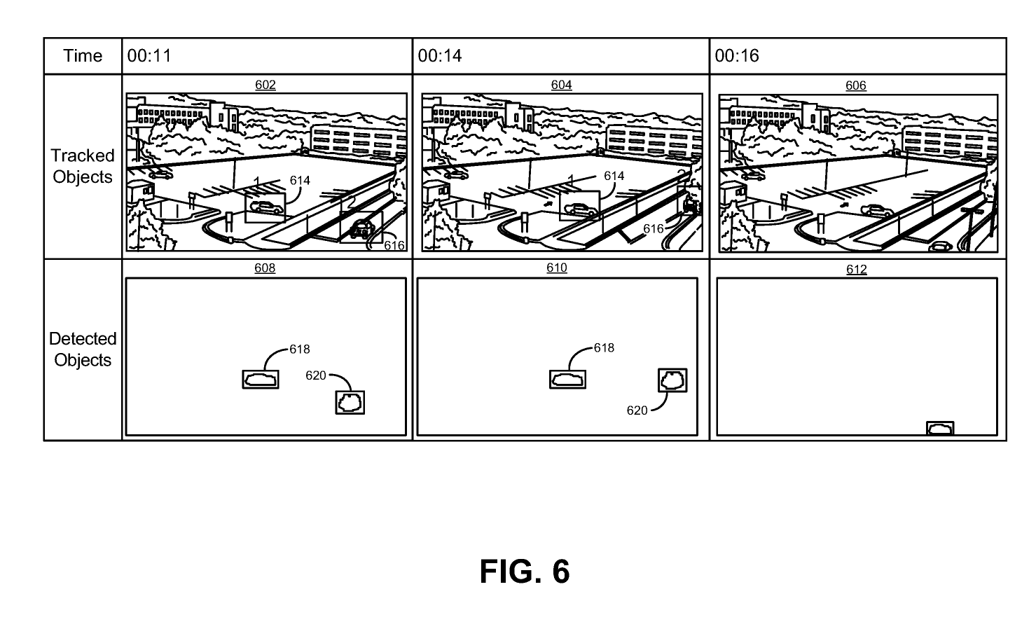

FIG. 6 is an illustration of video frames 602, 604, and 606 of an environment for which a sleeping object is detected and tracked using a simple background subtraction based solution. The frames 602, 604, 606 are shown with tracking results for different time instances of 11 seconds, 14 seconds, and 16 seconds, respectively. The background pictures 608, 610, and 612 (e.g., after blob analysis) are also shown with the object detection results of each time instance.

In the example shown in FIG. 6, a first moving car being tracked by a tracker bounding box 614 and a second moving car being tracked by a tracker bounding box 616 are detected in frame 602 at time instance 00:11. The two cars are detected as the blobs surrounded by blob bounding box 618 and blob bounding box 620, respectively, as shown in the background picture 608. The first car (tracked by tracker bounding box 614) continues moving until approximately frame 604 at time instance 00:14. The object tracking system can correctly detect and track the first car until that time (00:14), as illustrated by the blob bounding box 618 in the background picture 610 and by the tracker bounding box 614 in the frame 604. However, since the first car stopped moving from time instance 00:14 forward, the background subtraction model starts to learn the background models of the pixel locations related to the first car such that the foreground pixels soon become background pixels due to the nature of background subtraction, as noted above. The second car continues moving as each of the frames 602, 604, 606 are captured, and thus is detected and tracked for all three frames as illustrated by the blob bounding box 620 in the background pictures 608, 610, 612 and by the tracker bounding box 616 in the frames 602, 604, 606.

In some examples, a sleeping object can be detected, in part, by comparing bounding boxes of a blob tracker that is tracking the object across multiple frames. For example, it can be determined whether the bounding boxes of the tracker are becoming smaller across the frames, indicating that the object being tracked is being absorbed (or vanishing) into the background based on the background subtraction process. Detection of the sleeping object can be further based on a comparison of color characteristics (e.g., in an appearance model maintained for the tracker) of pixels included in bounding boxes of the blob tracker in a number of the frames. For example, the sleeping object detection system can maintain and periodically update an appearance model together with a target sleeping bounding box of the tracker. Once there is a sign that that the object is being absorbed into the background, the target sleeping bounding box (instead of the current bounding box) can be used to update or re-calculate the appearance model using pixels of the current frame within the target sleeping bounding box. The updated appearance model can be compared with an appearance model maintained for the tracker. If the comparison determines the texture is unchanged, the object can be considered a sleeping object. Such a comparison of color characteristics can ensure that the object the tracker is tracking (the sleeping object) remains in the scene.

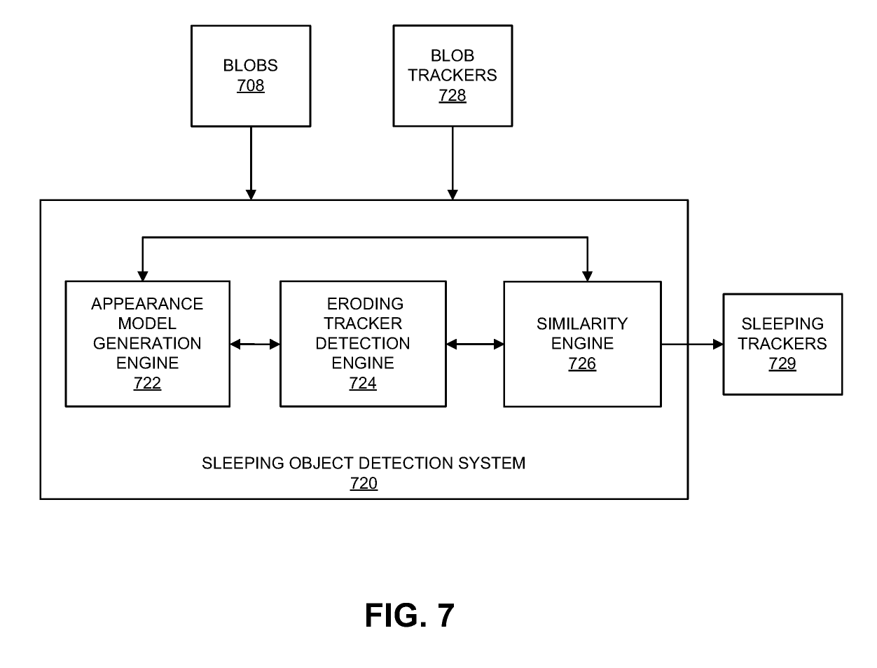

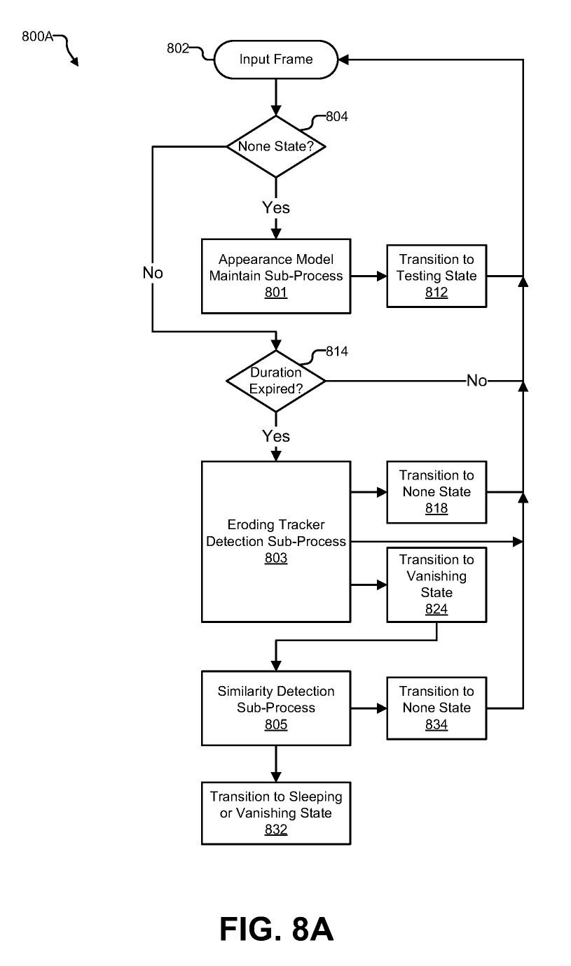

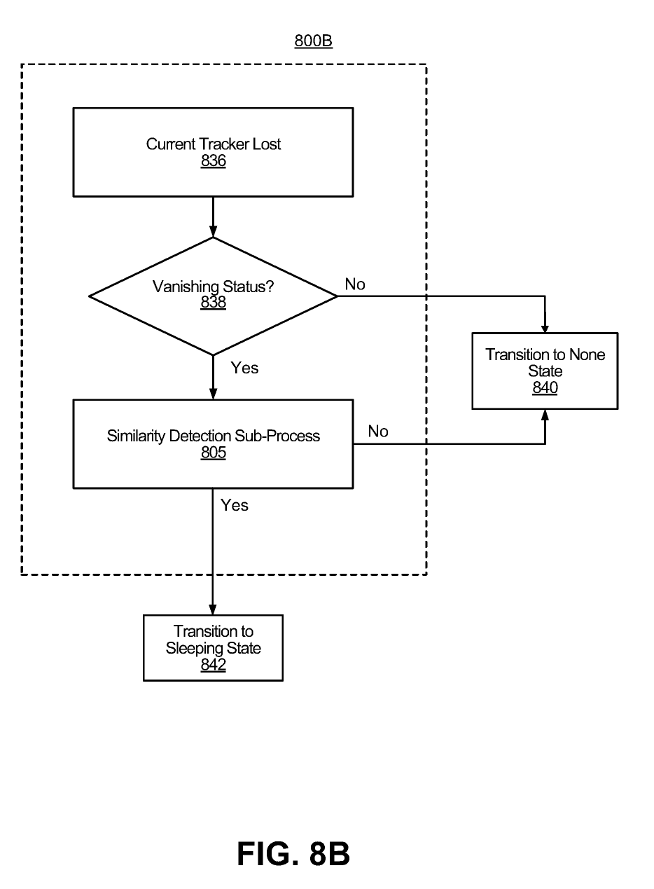

FIG. 7 shows an example of a sleeping object detection system 720 that can be used to perform a sleeping object detection process. An example of the sleeping object detection process is described below with respect to FIG. 8A and FIG. 8B. The sleeping object detection system 720 includes an appearance model generation engine 722, an eroding tracker determination engine 724, and a similarity engine 726. The sleeping object detection process can be performed on a frame-by-frame basis. The sleeping object detection system 720 receives as input the blobs 708 and the blob trackers 728. For example, the blobs 708 can include the blobs detected for one or more frames of a video sequence. The blob trackers 728 can include the blob trackers for the one or more frames of the video sequence. A blob tracker for a current frame can be the tracker before or after data association has been performed (e.g., before or after a Kalman filter update based on locations of blobs in a current frame). The output of the sleeping object detection system 720 includes the sleeping trackers 729.

The sleeping object detection system 720 can be part of a tracking system (e.g., the object tracking system 106), or can be a separate component from the tracking system. For example, the sleeping object detection system 720 can be separate from the object tracking system, in which case the sleeping trackers 729 can be output to the object tracking system so that the object tracking system can continue to track the sleeping objects. In other examples, the sleeping object detection system 720 can be part of (or integrated with) the object tracking system. For instance, the sleeping object detection system 720 may perform sleeping object detection after data association is performed by the data association engine 414. The sleeping trackers 729 determined for a current frame can also be provided for use by the tracking system to perform data association for a next frame (e.g., to associate the sleeping trackers to blobs in the next frame).

The appearance model generation engine 722 can determine appearance models for bounding boxes of the blob trackers 728. An appearance model of a bounding box can include one or more color characteristics of pixels included in the bounding box. For example, the one or more color characteristics can include a color feature space of pixels in the bounding box, a color mass center of pixels in the bounding box, any other suitable color characteristic, or a combination thereof. The appearance model of a bounding box can be determined based on the pixels of a given frame that are included in the bounding box of the blob tracker. For example, the one or more color characteristics of a tracker bounding box can be calculated using the values of pixels within the bounding box.

The eroding tracker detection engine 724 can perform an eroding tracker detection process to detect whether bounding boxes of a tracker are shrinking over a number of frames (or eroding). The eroding tracker detection process can include a size inclusion test and a significant size decrease test. For example, the eroding tracker detection engine 724 can perform a size inclusion test by comparing a current bounding box of a tracker (in a current frame) with a previous bounding box of the tracker (in a frame obtained earlier in time than the current frame) to determine if the current bounding box is within the previous bounding box. In some examples, the current bounding box is determined to be within the previous bounding box when a size of the current bounding box is smaller than a size of the previous bounding box. In some examples, the current bounding box is determined to be within the previous bounding box when a size of the current bounding box is smaller than a size of the previous bounding box and when the boundaries of the current bounding box are entirely within the boundaries of the previous bounding box.

In some examples, the location in the current frame of the current bounding box of the blob tracker can be determined so that the the eroding tracker detection engine 724 can determine if the current bounding box is within the previous bounding box. In some implementations, the location of the current bounding box in the current frame can be determined using the location of the blob that the tracker is associated with in the current frame. In some implementations, the location of the current bounding box in the current frame can be determined using a predicted location of the blob tracker, which is based on one or more previous locations of the tracker in one or more previous frames. For instance, as described above, the predicted location of a blob tracker in a current frame can include a location in a previous frame of a blob with which the blob tracker was associated.

In some examples, the previous bounding box can include a bounding box from any frame obtained before the current frame. In some examples, the previous bounding box can include a target sleeping bounding box (also referred to herein as a target bounding box). A target bounding box of a tracker is a bounding box for a frame that meets an appearance model duration. For example, the appearance model duration can be a threshold set to a certain number of frames (e.g., 15 frames, 30 frames, 60 frames, or other suitable number of frames). The appearance model duration can be implemented using a counter or other mechanism. In one illustrative example, the appearance model duration can be set to 30 frames, in which case a target bounding box can be set for a particular tracker every 30 frames.

When the size inclusion test is successful for a tracker (the current bounding box of the tracker is determined to be within the previous bounding box, such as the target bounding box), the eroding tracker detection engine 724 can perform the significant size decrease test to determine whether there has been a significant size decrease of the tracker's bounding boxes across frames. For example, the eroding tracker detection engine 724 can compare a size of the current bounding box of the tracker (in a current frame) with a size of a previous bounding box of the tracker (in a previous frame) to determine if the current bounding box is significantly smaller than the previous bounding box. As noted above, the previous bounding box can include a bounding box from any frame obtained before the current frame, or can include a target bounding box. The significant size decrease of a current bounding box can be based on a threshold amount as compared to the size of the previous bounding box. In some examples, the threshold amount can include a percentage size of the previous bounding box (e.g., 30%, 40%, 50%, or other suitable percentage). In one illustrative example, the current bounding box can be determined to be significantly smaller than the previous bounding box when the size of the current bounding box is smaller than the size of the previous bounding box by 50% or more (e.g., the current bounding box is at least half the size of the previous bounding box). The tracker can be determined to be a vanishing or eroding tracker when a significant size decrease is determined to have occurred to a bounding box of the tracker. In some cases, a state of the tracker can be set to vanishing or eroding.

In some examples, in addition to comparing the size of the current bounding box of the tracker with the size of the previous bounding box of the tracker, the eroding tracker detection engine 724 can determine if there has been a threshold number of bounding boxes or frames (e.g., at least three, four, five, or other suitable number of bounding boxes) involved in the eroding tracker detection process. In such examples, the tracker is considered a vanishing or eroding tracker when a bounding box is determined to have undergone a significant size decrease and when the threshold number of bounding boxes has been analyzed in the eroding tracker detection process.

The similarity engine 726 can compare appearance models of bounding boxes of a tracker to determine if color characteristics of the bounding boxes are similar enough to consider the tracker as a sleeping tracker. In some examples, the appearance model for the tracker can be updated and compared to a previous appearance model of the tracker once there is a clear sign that that the object is being absorbed into the background (based on the eroding tracker detection process). Such a comparison of color characteristics can ensure that the texture of the object the tracker is tracking (the potential sleeping object) remains unchanged, which can indicate that the object remains in the scene at the location it became stationary. In one illustrative example, the appearance model generation engine 722 can determine an initial appearance model of a target bounding box of the tracker using pixels of an initial frame. The initial frame is the frame at which the target bounding box was designated as the target bounding box (after the appearance model duration). The appearance model generation engine 722 can further determine a current appearance model of the target bounding box using pixels of the current frame. The similarity engine 726 can compare the current appearance model to the initial appearance model and can determine if the current and initial appearance models are within a threshold difference of one another to determine if the texture is unchanged. In such an example, the target sleeping bounding box (instead of the current bounding box) is used to re-calculate the appearance model of the current frame within the target sleeping bounding box, and the re-calculated appearance model is compared with the maintained initial appearance model.

The threshold difference can be set to a percentage of a dimension of the target bounding box (e.g., a percentage of the diagonal length of the bounding box). The percentage can include any suitable percentage, such as 5%, 10%, 15%, 20%, or other suitable percentage. In some examples, if the current and initial appearance models are within the threshold difference, the tracker is considered a sleeping tracker and is transitioned to a sleeping state or status. For instance, if the comparison determines that the texture is unchanged (based on the threshold difference), the object tracked by the tracker may be detected as a sleeping object. In some examples, if the current and initial appearance models are within the threshold difference, the tracker can be maintained in the vanishing state (instead of being transitioned to the sleeping state). In such examples, if the tracker is later detected as lost, the sleeping object detection system 720 can check if the tracker has a vanishing status. If the tracker has a vanishing status, the sleeping object detection system 720 can perform the similarity detection sub-process (described below) again, and if the similarity detection sub-process is successful, the tracker will be transitioned to a sleeping state or status. Further details of the sleeping object detection process are described below with respect to FIG. 8A and FIG. 8B.

FIG. 8A is a flowchart illustrating an example of a sleeping object detection process 800A for detecting sleeping objects and trackers in a scene. In some cases, the sleeping object detection system 720 can perform the process 800A. The process 800A can be performed for each frame of a sequence of video frames capturing images of the scene, or for a subset of all frames of the video sequence (e.g., every other frame, every three frames, every ten frames, or other subset). Further, the process 800A can be performed either serially or in parallel for each tracker of each input frame. In one illustrative example, the sequence of video frames can be captured by a video or image capture device (e.g., an IP camera, or other video or image capture device). In some examples, the video frames can be input to the process 800A as the video frames are captured. In some examples, the video frames can be stored in a storage device after being captured, and can be input to the process 800A from the storage device at some point after the frames are captured.

The process 800A includes several sub-processes, including an appearance model maintain sub-process 801, an eroding tracker detection sub-process 803, and a similarity detection sub-process 805. As described in more detail below, the appearance model maintain sub-process 801 can be performed to designate a bounding box of a tracker as a target sleeping bounding box and to calculate an appearance model for the target sleeping bounding box. The eroding tracker detection sub-process 803 can be performed to detect if bounding boxes associated with a certain tracked object and associated tracker are becoming smaller and smaller. The eroding tracker detection sub-process 803 can also be referred to as a vanishing blob detection sub-process. The similarity detection sub-process 805 can be performed to compare appearance models of bounding boxes associated with a certain tracked object and tracker, and, in some cases, to determine if the tracker is near or intersecting a boundary of a current video frame or picture.

The different sub-processes of the process 800A are performed based on current states of one or more blob trackers associated with the frames of the video sequence and based on defined periods. States of blob trackers can include a “none” state, a “testing” state, a “vanishing” state, a “lost” state, a “sleeping” state, or other suitable state. These states can be additional states that can be assigned to a tracker. In some cases, a tracker can have multiple states. For example, a tracker can have a “split” state at the same time as having a “vanishing” state, or can have a “merge” state at the same time as having a “sleeping” state, among other examples. The appearance model maintain sub-process 801 is performed for blob trackers having a “none” state. Trackers that do not have a “testing,” “vanishing,” or “sleeping” state will have a “none” state. For trackers having a “testing” state, the eroding tracker detection sub-process 803 is performed. For trackers having a “vanishing” state, the similarity detection sub-process 805 is performed. In some cases, a tracker may have both a “lost” state and a “vanishing” state. A tracker can be determined to be lost at a current frame when the tracker has no object to track in the current frame. For example, a tracker can be determined to be lost when a bounding box that the tracker was associated with in a previous frame is no longer in a current frame. In another example, a tracker can be determined to be lost when an object being tracked by the tracker leaves the scene, in which case the tracker may be found to not be associated with a bounding box, and thus may be transitioned to a “lost” state.

Different periods can also be defined for determining when to perform the various sub-processes for a particular tracker. For example, the condition to invoke the appearance model sub-process 801 for a tracker with a “none” state can be a periodical pattern, meaning that, while the tracker has the “none” state, the tracker will undergo the appearance model sub-process 801 once per interval of time. In some examples, the interval expires N % K (N modulo K) frames, where N is a counter associated with the tracker and K is an appearance model duration. As another example, the condition to invoke the eroding tracker detection sub-process 803 for a tracker with a “testing” state can also be a periodical pattern. In some examples, a testing interval occurs every N % L (N modulo L) frames, where N is the counter associated with the tracker and L is an eroding tracker duration. In some examples, N is set at 0 when the tracker first transitions to the “none” state, and increments with every frame. In some examples, N is set to a random value when the tracker transitions to the “none” state. In some examples, N is decremented from an initial value (e.g., a random value or a value equal to the relevant duration period).

In the example of FIG. 8A, a current input frame is received at step 802. The current input frame can be one frame from the sequence of video frames, and can be referred to herein as the current frame. At step 804, the process 800A includes determining whether the states of one or more blob trackers for the current frame have a “none” state. The states of the trackers associated with the current frame can be checked serially or in parallel.

For trackers associated with the current frame that have the “none” state, the appearance model duration may be checked to determine whether to perform the appearance model maintain sub-process 801. Once a tracker is in the “none” state, the initial bounding box after the appearance model duration is met is kept as a target sleeping bounding box. The current frame at which at which the target bounding box is designated as the target bounding box is referred to herein as the initial frame. The initial bounding box is the first bounding box of the current tracker after the appearance model duration is met (e.g., the bounding box in the initial frame). The target sleeping bounding box can be used as a reference for comparison with other bounding boxes of the current tracker that track the same object as the target sleeping bounding box in subsequent frames. The remaining steps of process 800A are discussed with reference to the bounding boxes of the current tracker in the initial frame and in one or more subsequent frames obtained after the initial frame. However, one of ordinary skill will appreciate that the steps can also be performed for other trackers of the current frame.

Once a target sleeping bounding box is generated, an appearance model of the target sleeping bounding box is generated for the initial frame (e.g., the frame at which the target bounding box was designated as the target bounding box) using pixels of the initial frame. An appearance model of a bounding box includes one or more color characteristics of the pixels included in the bounding box. The appearance model calculated for the target sleeping bounding box using pixels of the initial frame is denoted as the initial appearance model. The appearance model can be updated by calculating appearance models for bounding boxes of the tracker in one or more subsequent frames obtained after the initial frame. In some implementations, an appearance model may be calculated for each bounding box of the tracker at each frame. In some implementations, for the purpose of detecting the sleeping objects, lower frequency updating of the appearance model can be sufficient because, once the object starts to fade into the background, it may take seconds to complete the process 800A, and a delay of several frames in the initial stage (of the fading) may not cause huge bounding box differences in terms of both location and size.

An appearance model of a bounding box includes one or more color characteristics of the pixels included in the bounding box. For example, the one or more color characteristics can include a color feature space of pixels included in the bounding box, a color mass center of pixels included in the bounding box, or a combination thereof. In some examples, the color feature space can be the quantized color spaces, using the luminance (Y) and hue (H) components of an HSV color space. In some examples, the features of the feature space may be from the Y, U and V components of a YUV color space (e.g., the YUV 4:2:0 space, YUV 4:4:4 space, YUV 4:2:2 space, or other suitable YUV color space). In some examples, the color mass center of the appearance model of each bounding box can be calculated by counting the mass center of the feature space applied to the pixels within the bounding box. For instance, a color probability model can first be determined by calculating the probability of the feature value in each pixel location, and then the mass center of all pixels within the whole bounding box can be calculated according to the per-pixel probability model.

In some cases, when calculating the color probability model, the color space of the bounding box may need to be quantized so that the probability model is limited to contain only up to a fixed number of entries (e.g., 1024 for Y and H component or 2048 for YUV). In some cases, when calculating the color mass center, the pixel locations may also need to be quantized. For example, when contributing to the calculation of the mass center, the X and Y coordinate may be quantized (e.g., by a right shift of 2 (divided by 4), or other suitable amount) such that the bounding box is divided into small grids. Even though each pixel within a grid may have a different probability, each pixel's coordinates are considered the same when calculating the mass center. Using such quantized pixel locations can allow the process 800A to be more robust to distortions (e.g., a small phase shift of the pixels of input images).

Detailed implementations are now described as illustrative examples. An illustrative example of an implementation of the YUV color probability model includes (Note that this process establishes an appearance model which is illustrated by the array of HIST):
1. Initialize the color histogram HIST to all zeros.
2. For each pixel P in the bounding box, get its Y, U, V components, each components are 8 bits.
3. Quantize the YUV components as Y=Y>>3, U=U>>5, V=V>>5; [with >> being a right bit shift operator]
4. The HIST index is given by idx=(Y<<6)+(U<<3)+V; [with << being a left bit shift operator]
5. Then increase the HIST(idx) by 1.
6. Finally, HIST is normalized by the bounding box size.

An illustrative example of an implementation of the mass center calculation includes:
1. Initialize the mass center (CX, CY) as (0, 0). Set the sum of probability P_SUM=0.
2. Given the color histogram HIST, for each pixel P in the bounding box, get its Y, U, V components and do the following:
3. Quantize the YUV components as Y=Y>>3, U=U>>5, V=V>>5;
4. The HIST index is given by idx=(Y<<6)+(U<<3)+V;
5. P_SUM=P_SUM+HIST(idx)
6. Get the pixel coordinates X and Y.
7. Update the mass center as CX=CX+(X>>2)*HIST(idx), CY=CY+(Y>>2)*HIST(idx).
8. Finally, normalize the (CX, CY) by the P_SUM.

In the frame the appearance model is just calculated for, the mass center can be calculated (similarly as in step 6 and step 7) in order to know the initial mass center of the appearance model. In some cases, the appearance model of each bounding box is designed in a way that all pixels of a bounding box are maintained. In other cases, the appearance model of each bounding box is designed in a way that it is always of a constant size regardless of the bounding box size. In such cases, the possibility of uncontrollable memory increase is avoided, which may occur when multiple large bounding boxes exist.

In some cases, once the target sleeping bounding box is determined for the current tracker, the current tracker is transitioned to the “testing” state at step 812. In some cases, the current tracker is transitioned to the “testing” state (at step 812) once the appearance model is calculated for the target sleeping bounding box. At a later point in time, if the state of the current tracker is transitioned to the “none” state (e.g., after the size inclusion test, after the significant size decrease, after the mass center similarity test, or at some other point during the process 800A), the target sleeping bounding box for the current tracker will be changed to another bounding box of the current tracker for a different initial frame.

While the current tracker is in the “testing” state, a bounding box history of the tracker is maintained that includes each bounding box of the tracker in one or more subsequent frames after the initial frame. In some cases, the bounding boxes within the history for the tracker present a shrinking behavior of the tracker when the tracker is tracking an object in motion that becomes stationary in the scene (a potential sleeping tracker). The bounding box history of a tracker is kept and is updated as subsequent input frames (after the initial frame) and associated bounding boxes of the tracker are processed. By keeping and updating the history of bounding boxes for the tracker, it is ensured that once the detection of a vanishing tracker is confirmed (during the eroding tracker detection sub-process 803 below), the original bounding box at the time instance (or frame) the object became vanishing is available.

The eroding tracker detection sub-process 803 is applied once the tracker is in the “testing” state and the eroding tracker detection duration has been met (e.g., once for every L frames, such as every 15 frames, every 30 frames, or the like). For example, at step 814, the eroding tracker detection duration is checked for the current tracker in one or more subsequent frames (determined based on the eroding tracker detection duration) after the initial frame at which the target bounding box was designated, and if the eroding tracker detection duration has been met, the eroding tracker detection sub-process 803 is performed. In some examples, the frequency of eroding tracker testing (the eroding tracker detection duration) can be made higher than the frequency of the appearance model maintain sub-process 801 (the appearance model duration). In some examples, the eroding tracker detection duration and the appearance model duration include the same period (e.g., same number of frames or same time period).

The eroding tracker detection sub-process 803 includes comparing a tracker's bounding box of a newly received input frame (now the current frame) to the bounding boxes of the same tracker but in previous frames (e.g., the target sleeping bounding box). For example, the eroding tracker detection sub-process 803 can include a size inclusion test and a significant size decrease test.

Once the eroding tracker detection duration is determined to have been met at step 814 (e.g., a threshold number of frames has been received), the size inclusion test is performed on a current bounding box of the current tracker for the current frame. For a vanishing tracker (and potentially a sleeping tracker), the region of the bounding box in the current frame should be within the bounding box of a previous frame (e.g., the target sleeping bounding box). The size inclusion test can be applied to determine whether the current bounding box of the current frame is included in a previously tested bounding box of the same tracker. For example, the previously tested bounding box can include the target sleeping bounding box of the current tracker.

In one illustrative example, the size inclusion test compares the current bounding box of the current tracker with the target sleeping bounding box of the current tracker. In some examples, the size inclusion test can be based on sizes of the current and target bounding boxes. In such examples, the current bounding box is determined to be within the target sleeping bounding box when a size of the current bounding box is smaller than a size of the target sleeping bounding box. In some examples, the size inclusion test can be based on sizes of the current and target bounding boxes as well as the location of the current bounding box relative to the target bounding box. In such examples, the current bounding box is determined to be within the target sleeping bounding box when the size of the current bounding box is smaller than the size of the target sleeping bounding box and when the boundaries of the current bounding box are entirely within the boundaries of the target sleeping bounding box. The location of the current bounding box can be the current tracker's identified location in the current frame (based on a blob location the tracker is associated with in the current frame) or the current tracker's predicted location from a previous frame (a location in the previous frame of a blob with which the blob tracker was associated).

If the current bounding box is determined to be included in the target sleeping bounding box or other previous bounding box, the inclusion test is successful and the state of the tracker can be maintained or transitioned to a “testing” state. However, if the current bounding box is determined to not be included in the target sleeping bounding box or other previous bounding box, the inclusion test fails and the state of the tracker can be transitioned to the “none” state at step 818. For example, if the size inclusion condition is not met, the eroding tracker detection sub-process 803 terminates by transitioning the tracker to the “none” state at step 818.

The significant size decrease test is applied when the current tracker is maintained or transitioned to the “testing” state (after the size inclusion test is successful). The significant size decrease test can be performed to determine whether there has been a significant size decrease of the current tracker's bounding boxes since the initial frame at which the target sleeping bounding box was designated. For example, a size of the current bounding box of the current tracker can be compared to a size of a previous bounding box of the tracker (in a previous frame) to determine if the current bounding box is significantly smaller than the previous bounding box. In some cases, the previous bounding box can be the target sleeping bounding box of the current tracker. In some cases, the previous bounding box can include a bounding box (of the current tracker) from any frame obtained between the initial frame and the current frame.

The significant size decrease test can be based on a threshold amount of size reduction in the current bounding box as compared to the size of the target sleeping bounding box (or other previous bounding box). For example, the threshold amount can include a percentage size (e.g., 30%, 40%, 50%, or other suitable percentage) of the target sleeping bounding box. In one illustrative example, the current bounding box can be determined to be significantly smaller than the target sleeping bounding box (a significant size decrease has occurred) when the size of the current bounding box is at least 50% smaller than the size of the target sleeping bounding box. In such an example, if the current bounding box is at least half the size of the target sleeping bounding box, the current bounding box is determined to have undergone a significant size decrease as compared to the target sleeping bounding box.

In some examples, in addition to comparing the size of the current bounding box of the tracker with the size of the previous bounding box of the tracker, the significant size decrease test can further determine if there has been a threshold number of bounding boxes or frames (e.g., at least three, four, five, or other suitable number of bounding boxes) involved in the eroding tracker detection sub-process 803 for the current tracker (e.g., since the current target sleeping bounding box for the current tracker was generated). In one illustrative example, the significant size decrease test is met when the current bounding box has undergone a significant size decrease and if there have been at least three (or other suitable number) bounding boxes involved in the eroding tracker detection sub-process 803 for the current tracker.

The current tracker can be determined to be a vanishing or eroding tracker when the significant size decrease test is met by the current bounding box (e.g., the current bounding box is determined to have undergone a significant size decrease and, in some cases, when the threshold number of bounding boxes has been analyzed in the eroding tracker detection sub-process 803). For example, the state of the current tracker can be transitioned from a “testing” status to a “vanishing” or “eroding” status at step 824 when the significant size decrease test is satisfied.

If the significant size decrease test is not met, the state of the current tracker can be maintained in the “testing” state. Input frames are then received until the next eroding tracker detection duration is met at step 814 (e.g., a threshold number of frames has been received). A new current bounding box of a new current frame can then be analyzed using the size inclusion test and, if the size inclusion test is met, using the significant size decrease test.

The similarity detection sub-process 805 is performed for trackers having a “vanishing” status. The similarity detection sub-process 805 can be performed, in part, to verify that the object or blob being tracked by the current tracker (the potential sleeping object) remains in the same location in the scene as it was located when the target sleeping bounding box was generated. In some cases, the similarity detection sub-process 805 can also determine if the current tracker is within a certain distance of a boundary of the frame or picture, or if the current tracker is intersecting the boundary.

The similarity detection sub-process 805 calculates, an appearance model using the pixels of the current frame based on the target sleeping bounding box. The appearance model calculated for the target sleeping bounding box using the pixels of the current frame is referred to as the current appearance model. For example, the current appearance model is calculated using the pixels in the current frame that the target sleeping bounding box would contain if included in the current frame. A mass center similarity test is also performed. The mass center similarity test includes comparing a similarity between the current appearance model and the initial appearance model. As previously described, the initial appearance model is the appearance model calculated by the appearance model maintain sub-process 801 the target sleeping bounding box using pixels of the initial frame for which the target sleeping bounding box was designated.

In one illustrative example of the mass center similarity test, the probability color histogram model for the initial appearance model is denoted as M, and the corresponding mass center for the initial appearance model is denoted as C0. The probability color histogram model M can be used to calculate the mass center C of the current appearance model. For example, the mass center C can be calculated using the example mass center calculation described above. The histogram (denoted as HIST above, illustrating the appearance model) can be calculated in a previous frame using the example appearance model calculation above. Values of C and C0 are then compared to determine how close together the values are. If C0 and C are very close to each other, according to a similarity threshold, the corresponding tracker is detected as a sleeping object tracker. In some examples, the mass center similarity test can be denoted as |C0−C|<α, (wherein |.| is, e.g., the L-2 norm) for some α>0 (wherein a is the similarity threshold). In one illustrative example, the similarity threshold a may be set to be a percentage (e.g., 5%, 10%, 15%, or other suitable percentage) of the diagonal length of the target sleeping bounding box B0. For example, if the difference between the mass center C of the current bounding box and the mass center C0 of the initial bounding box is within the threshold percentage of the diagonal length of the target sleeping bounding box B0, the similarity between the mass centers C and C0 meets the mass center similarity test.

If the similarity between the mass center computed by the similarity detection sub-process 805 (mass center C) and the mass center computed by the appearance model maintain sub-process (mass center C0) is not sufficient, the current tracker is transitioned to a “none” state at step 834. For a future iteration of the process 800A for the current tracker, step 804 will result in a “yes” decision and the appearance model maintain sub-process 801 can be performed to create a new target sleeping bounding box for the current tracker.

In some implementations, if the similarity between the mass centers C and C0 is sufficient, the current tracker is detected to be a sleeping object tracker that is tracking a sleeping object. For example, the current tracker can be transitioned to a “sleeping” state at step 832. In such implementations, the sleeping tracker can then be output to a tracking system (e.g., object tracking system 106) so that the tracking system can continue tracking the sleeping object. For example, the tracker can be shown as tracking the sleeping object with a bounding box that is in the same location as the target sleeping bounding box, or in a location of a bounding box of a frame received after the initial frame for which the target bounding box was designated.

In some implementations, after the similarity detection sub-process 805 is performed, the current tracker can be kept as a vanishing tracker until the current tracker is detected to be lost. As noted previously, a tracker can be determined to be lost for a current frame when the tracker has no object to track in the current frame (e.g., when a bounding box that the tracker was associated with in a previous frame is no longer in the current frame, when an object being tracked by the tracker leaves the scene, or the like). In such implementations, if the similarity between the mass centers C and C0 is sufficient, the current tracker is maintained in the vanishing state at step 832 (instead of being transitioned to the sleeping state). If the tracker is later detected as being lost, the sleeping object detection system 720 can check if the tracker has a vanishing status. If the tracker has a vanishing status, the sleeping object detection system 720 can perform the similarity detection sub-process 805 again for the current tracker. If the similarity detection sub-process 805 determines the similarity between the later mass center and the initial mass center is sufficient (and, in some cases, determines the tracker is not too close to a boundary, as described below), the tracker will be transitioned to a sleeping state.

The process 800B shown in FIG. 8B can be performed to determine whether to transition the current tracker to the sleeping state. At step 836, the current tracker is determined to be lost in a subsequent frame obtained after the current frame for which the frame was determined to be vanishing. For example, it can be determined that the current tracker is not associated with any bounding box in the current frame, in which case the tracker is determined to be lost. When the tracker is determined to be lost, the process 800B can determine whether the current tracker has a vanishing status at step 838. If the current tracker is determined to have a vanishing status (a “yes” decision at step 838), the similarity detection sub-process 805 can be performed again for the current tracker. For example, the appearance model can be updated (a new current appearance model) using the pixels of the subsequent frame based on the target sleeping bounding box, and a new mass center similarity test can be performed using the updated appearance model. The similarity detection sub-process 805 can then determine whether the similarity between updated mass center C and the initial appearance model mass center C0 is sufficient. If it is determined that the mass centers C and C0 are similar enough, the tracker will be transitioned to a sleeping state at step 842. At step 838, if the current tracker is determined not to have a vanishing status, current tracker is transitioned to the “none” state at step 840. If the similarity detection sub-process 805 is not satisfied, the current tracker is transitioned to the “none” state at step 840.

As illustrated in FIG. 8A, once a tracker has gone through the “vanishing” status, it is either maintained in the vanishing status, detected as a sleeping object tracker with a sleeping status, or its status is set to “none”, in which case the process 800A analyzes future frames for possible sleeping objects. In some cases, as an alternative, when a tracker having a “vanishing” state is not detected as a sleeping object tracker, the appearance model together with the target sleeping bounding box of the current tracker can be updated and the current tracker can be transitioned to the “testing” state. In such cases, the frequency of the appearance model update can be increased when the tracker is already in the “vanishing” state, allowing more chances to capture at least part of an object turning into a sleeping object. For example, as noted previously, the eroding tracker detection duration can be shorter than the appearance model duration in some implementations.

Sleeping object detection and tracking can improve object tracking. In some cases, however, sleeping object detection can erroneously classify a moving object as a sleeping object. For example, a moving object may be detected, and a bounding box can be assigned to the object to track the object. In this example, the moving object may later split into two objects, where one of the split objects continues moving while the other split object remains stationary. The stationary object may begin to vanish (e.g., becoming absorbed into the background model), and at this point be classified as a sleeping object. The stationary object, however, may, in fact, be an object that is part of the background of the scene, and thus should be allowed to vanish and not be tracked by the object tracking system. For example, the background object may be a door, a curtain, a chair, and/or any other suitable background object that an actual foreground object may overlap with in a scene. In the example above, a person may have opened the door or moved the chair, and during this movement the person and the object may have been identified by one bounding box. Once the person has moved away from the door or chair, the object tracking system may have identified a split event, with the door or chair being one split object and the person being another split object. After the split event, the door or chair should become part of the background, and should not be falsely detected as a sleeping object that continues to be tracked.

Objects in a scene can also move on their own accord and for short periods, and once stationary, may be incorrectly identified as sleeping objects. For example, tree leaves can be disturbed by wind, in which case the tree leaves can be detected as one or more moving objects. Once the wind stops and the leaves become stationary, the leaves may begin to vanish into the background (e.g., based on the background model detecting the leaves as background). Sleeping object detection, however, may falsely detect the vanishing leaves as one or more sleeping objects, when the leaves should, in actuality, be allowed to vanish into the background and should not be tracked by the object tracking system.

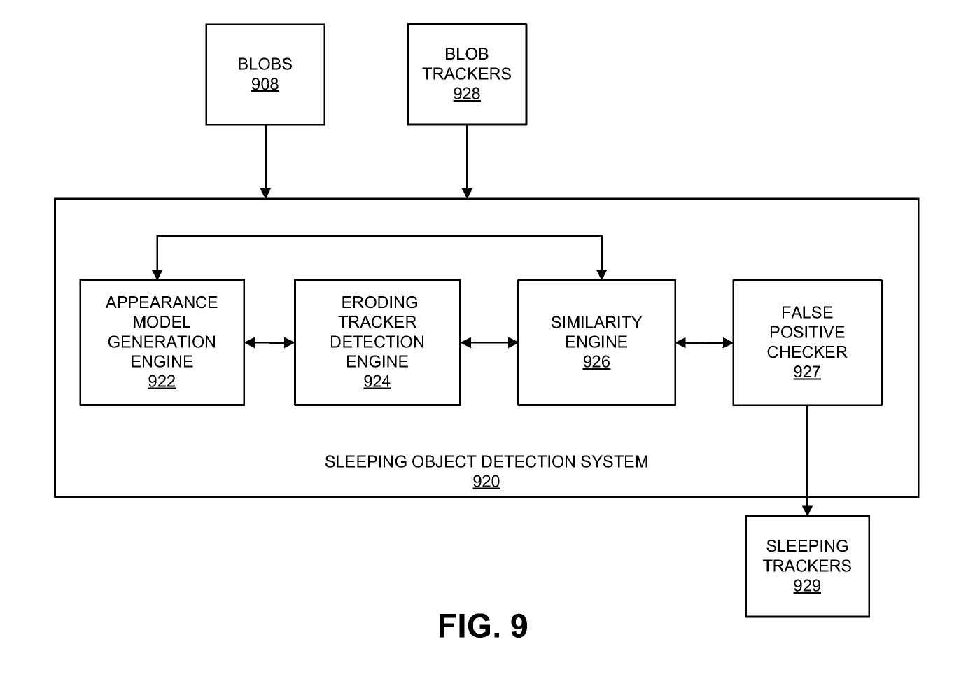

A sleeping object detection system is described herein that can detect sleeping object trackers for a sequence of video frames, while also preventing false positive detection of sleeping object trackers. FIG. 9 illustrates an example of a sleeping object detection system 920 that includes a false positive checker 927. The sleeping object detection system 920 also includes an appearance model generation engine 922, an eroding tracker detection engine 924, and a similarity engine 926. The example sleeping object detection system 920 can receive, as inputs, blobs 908 and blob trackers 928. The blobs 908 can be, for example, blobs detected in one or more frames of a video sequence (e.g., by a blob detection system, such as blob detection system 104). The blob trackers 928 can include trackers determined for the frames in the video sequence (e.g., by an object tracking system, such as object tracking system 106). A blob tracker for the current frame can be the tracker before or after data association has been performed (e.g., by the object tracking system). The output of the sleeping object detection system 920 includes sleeping trackers 929. The sleeping trackers 929 can also be referred to as sleeping object trackers.

The appearance model generation engine 922 is similar to and can perform one or more of the same operations as the appearance model generation engine 722 described above with respect to FIG. 7. For example, the appearance model generation engine 922 of FIG. 9 can determine appearance models for bounding boxes associated with the blob trackers 928. An appearance model of a bounding box can include one or more characteristics of pixels included in the bounding box. The appearance model can be determined from a current input frame.

The eroding tracker detection engine 924 is similar to and can perform the one or more of the same operations as eroding tracker detection engine 724 described above with respect to FIG. 7. For example, the eroding tracker detection engine 724 can perform eroding tracker detection, also referred to as vanishing object detection. The eroding tracker detection engine 924 of FIG. 9 can determine whether bounding boxes associated with a tracker are shrinking over the course of a number of frames. Successive bounding associated with the same tracker can become smaller and smaller as pixels from the blob associated with the tracker become absorbed into the background model.

The similarity engine 926 is similar to and can perform one or more of the same operations as similarity engine 726 described above with respect to FIG. 7. For example, the similarity engine 926 of FIG. 9 can compare appearance models to determine whether one appearance model is similar to another appearance model. The appearance models being compared can be from different bounding boxes (e.g., in two or more video frames) for a same tracker. For example, one appearance model can have been determined using a prior bounding box (e.g., in a target sleeping bounding box), and a second appearance model can have been determined using a current bounding box. Alternatively or additionally, the second appearance model can be determined from a target sleeping bounding box when a target sleeping box was generated by appearance model generation engine 922. When the appearance models are sufficiently similar (e.g., within a threshold amount), the tracker may be associated with a sleeping object.

The false positive checker 927 can verify whether an object tracker determined to be for a sleeping object should, in fact, be classified as a sleeping tracker. As discussed further below, the false positive checker 927 can include a relevant tracker check, which can examine trackers that may be relevant to the tracker determined to be for a sleeping object. Relevant trackers include split trackers from a split group. The false positive checker 927 can also include a maturity check. The maturity check can examine the age of a potential sleeping tracker. The age of a potential sleeping tracker can be how long the tracker has been in existence relative to a certain state of the tracker. The maturity check can also examine a movement history of the tracker. When the false positive checker 927 has verified that a potential sleeping object should be treated as a sleeping object, the false positive checker 927 can change the state of the tracker being used to track the object to a sleeping state, and can output a sleeping tracker for the object. When false positive checker 927 determines that the object is not a sleeping object, in some implementations, the false positive checker 927 may make no changes to the object tracker for the object, so that the object associated with the tracker is able to erode into the background and is not tracked. In some implementations, the false positive checker 927 can delete the tracker associated with an object when it is determined that the object is not a sleeping object, since the object associated with the tracker is assumed to be background. For example, the tracker can be removed (or deleted) from a list of trackers maintained for the sequence of video frames being analyzed. In some implementations, the false positive checker 927 can change the state of the tracker to a lost state when it is determined that the object is not a sleeping object.

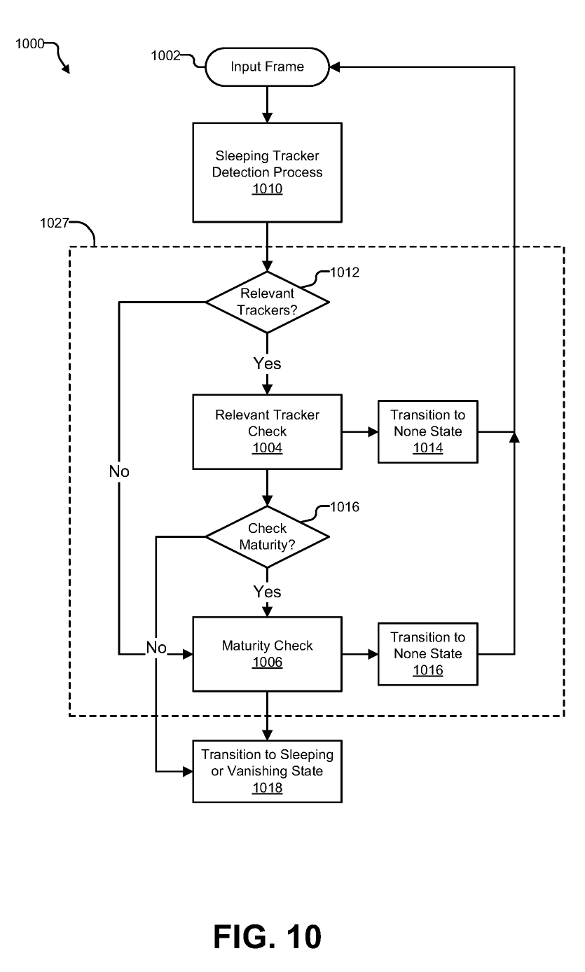

FIG. 10 illustrates an example of a process 1000 for sleeping object detection that includes false positives review process 1027. In some cases, the sleeping object detection system 920 can perform the process 1000. The process 1000 can be performed for each tracker in each frame from a sequence of video frames that capture images of a scene, or for a subset of frames in the video sequence. The process 1000 can further be performed serially or in parallel for each tracker of an input frame.

The example process 1000 includes a sleeping tracker detection process 1010. The sleeping tracker detection process 1010 includes the steps of the sleeping object detecting process 800A and the process 800B for determining whether to transition a tracker to the sleeping state. Similar to the processes discussed above (e.g., process 800A illustrated in FIG. 8A), the sleeping tracker detection process 1010 of FIG. 10 can include an appearance model maintain sub-process, an eroding tracker detection sub-process, and a similarity detection sub-process. The sleeping tracker detection process 1010 can operate on trackers from a current input frame 1002. An input tracker can initially have a “none” state (in addition to or as an alternative to any other state, such as new, hidden, normal, and/or other state described herein). In various implementations, the sleeping tracker detection process 1010 can transition the tracker to a “testing” state when a tracker is a candidate for becoming a sleeping tracker, as described above. As also described above, the sleeping tracker detection process 1010 can, for a later input frame 1002, transition to tracker back to a “none” state or to a “vanishing” state. The sleeping tracker detection process 1010 can transition trackers that are in a “vanishing” state to a “sleeping” state, as previously described.

In the example process 1000 of FIG. 10, trackers that the sleeping tracker detection process 1010 is considering for transition from the “vanishing” state to the “sleeping” state are output by the sleeping tracker detection process 1010 for consideration by the false positives review process 1027. A tracker being considered by the false positives review process 1027 will be referred to as a candidate sleeping tracker. A candidate sleeping tracker can be associated with a target sleeping bounding box, determined by the appearance model maintain sub-process of the sleeping tracker detection process 1010 using the techniques described above.

At step 1012, the false positives review process 1027 determines whether there are any relevant trackers for the candidate sleeping tracker. Relevant trackers include trackers from a split group. At step 1012, the false positives review process 1027 thus determines whether the candidate sleeping tracker resulted from a split in the current input frame 1002 or in a previous input frame. The false positives review process 1027 can determine, for example, that the candidate sleeping tracker currently has a split state, or that a bounding box in the candidate sleeping tracker's history of bounding boxes had a split state. Other trackers that resulted from the split are considered relevant trackers to the candidate sleeping tracker.

When a candidate sleeping tracker does not have relevant trackers (e.g., other trackers in the split group that resulted from the split), the false positives review process 1027 continues to the maturity check 1006, discussed further below. When the candidate sleeping tracker does have relevant trackers, the false positives review process 1027 proceeds to a relevant tracker check 1004.

In various implementations, the relevant tracker check 1004 can examine each of the trackers in the split group to which the candidate sleeping tracker belongs (e.g., the candidate sleeping tracker itself and any relevant trackers). In some implementations, for each tracker in the split group, the relevant tracker check 1004 can first determine whether the tracker has become lost (e.g., the object being tracked by the tracker can no longer be found in the input frame 1002). In some cases, trackers that have become lost are not considered any further by the process 1000. In some implementations, the relevant tracker check 1004 does not consider whether the trackers in the split are lost or not. While examples below describe the relevant tracker check 1004 considering only trackers that are not lost, one of skill will appreciate that the same sub-processes can be applied to lost trackers.

For trackers in the split group that are not lost (e.g., trackers having a split, normal, recover, or possibly merge state), the relevant tracker check 1004 next considers whether the bounding box for the tracker is within the target sleeping bounding box that is associated with the candidate sleeping tracker. Being within the target sleeping bounding box, in this context, means that the bounding box of the tracker from the split group is partially or fully within the boundaries of the target sleeping bounding box. When the tracker bounding box is partially within the target sleeping bounding box, then the tracker is considered within the target sleeping bounding box when the bounding box for the tracker and the target sleeping bounding box overlap by a threshold amount (e.g., 85%, 90%, or another suitable value).

When at least one tracker from the split group that is not lost is within the target sleeping bounding box, then the false positives review process 1027 can determine that the candidate sleeping tracker should not be a sleeping tracker. In this case, the false positives review process 1027 transitions the candidate sleeping tracker to the “none” state, at step 1014.

In some implementations, before transitioning the candidate sleeping tracker to the “none” state at step 1014, the relevant tracker check 1004 can first verify that the tracker that is within the target sleeping bounding box is the candidate sleeping tracker. For example, when the candidate sleeping tracker resulted from a split event, and the candidate sleeping tracker has remained stationary since the split event, then the candidate sleeping tracker is likely a moveable part of the background, and should not be considered a sleeping tracker.

If the relevant tracker check 1004 determines that no tracker from the split group is within the target sleeping bounding box associated with the candidate sleeping tracker, then, at step 1016, the false positives review process 1027 determines whether to check the maturity of the candidate sleeping tracker. In some cases, the false positives review process 1027 is configured to always check the candidate sleeping tracker's maturity when the relevant tracker check 1004 determines that the candidate sleeping tracker is still a candidate. In some cases, the false positives review process 1027 never checks the candidate sleeping tracker's maturity after examining relevant trackers, such that the test at step 1016 always result in a “no” result. In some cases, certain candidate sleeping trackers go through the maturity check 1006; for example, candidate sleeping trackers that overlapped with the target sleeping bounding box but failed the overlap threshold may be checked by the maturity check 1006.

When, at step 1016, the false positives review process 1027 determines not to check a candidate sleeping tracker's maturity, the false positives review process 1027 proceeds to step 1018, where the candidate sleeping tracker is transitioned to either the sleeping or vanishing state.

When, at step 1016, the false positives review process 1027 determines to check the candidate sleeping tracker's maturity, the false positives review process 1027 proceeds to the maturity check 1006. In various implementations, the maturity check 1006 measures the candidate sleeping trackers maturity using a duration, tDuration. The maturity check 1006 can also examine movement information, fMove, where the movement information can be derived from a history of bounding boxes for the candidate sleeping tracker. In some cases, fMove is determined from the last n bounding boxes for the candidate sleeping tracker (e.g., the last 2, 5, 10, or some other number of bounding boxes). In some cases, fMove is determined from the bounding boxes captured since the candidate sleeping tracker was transitioned to a normal tracker.

In some implementations, tDuration starts when the candidate sleeping tracker was transitioned to a normal tracker. For example, tDuration can start when the candidate sleeping tracker was transitioned to a normal tracker during processing of a previous video frame. In some implementations, tDuration can be computed as nLifeTime−nNewTrackerTime, where nLifeTime is the number of frames since the frame at which the candidate sleeping tracker was first generated, and nNewTrackerTime is the number of frames that the candidate sleeping tracker was a new tracker (e.g., had a new status). In these implementations, tDuration can thus include the time or number of frames that the candidate sleeping tracker has been a normal, merge, split, or recover tracker (e.g., as indicated by the number of frames the candidate sleeping tracker has been in existence minus the number of frames the tracker was new).

In some implementations, fMove estimates the amount by which the object associated with the candidate sleeping tracker has moved. To determine fMove, the maturity check 1006 can determine a ratio of horizontal to vertical movement from the bounding boxes in the history of the candidate sleeping tracker. For example, the maturity check 1006 can use the bounding boxes to determine a maximum horizontal and a maximum vertical movement across the bounding boxes in the history. In some cases, to normalize between different sizes of objects in the scene, the maturity check 1006 can further divide the horizontal and vertical movements by the average width and height, respectively, of the bounding boxes. In such cases, a ratio of the horizontal movement to the average width and a ratio of the vertical movement to the average height are produced. In this example, fMove can be equal to tDuration multiplied by the larger of the horizontal ratio or the vertical ratio.

In various implementations, the maturity check 1006 can use two thresholds to test a candidate sleeping tracker's maturity. The duration (tDuration) can be compared against a duration threshold, T, and the movement information can be compared against a movement threshold, Tc. When tDuration is greater than or equal to T, and when fMove is greater than or equal to Tc, the maturity check 1006 can determine that the object associated with the candidate sleeping tracker is mature enough to be considered a sleeping object. Such a determination can indicate that the object has been moving for long enough that the movement is not merely transient. In such a case, the candidate sleeping tracker is transitioned, at step 1018, to the “sleeping” or “vanishing” state. When tDuration is less that T or fMove is less than Tc, it can be determined that the candidate sleeping tracker fails the maturity check 1006. In this case, the movement may have been to brief and/or too small for the object to be considered independent of the background. In such a case, the candidate sleeping tracker is transitioned thus, at step 1016, to the “none” state.

When the candidate sleeping tracker passes the maturity check 1006, the false positives review process 1027 has determined that the candidate sleeping tracker is not a false positive. At step 1018, the false positives review process 1027 thus transitions the candidate sleeping tracker to the “sleeping” state.

In various implementations, the thresholds T and Tc can be set to different values for different applications. For example, when the video analytics system is being use for home security, distances between objects and the camera can be short and movements by objects can cover large areas of the frame. In one illustrative example for a home security case, T can be set to 100, and Tc can be set to 150. In other examples (e.g., for outdoor scenes, for large indoor scenes, or the like), objects may be quite far from the camera, such as 100 feet away or more. In these examples, T and Tc can be set to, for example, 200 and 700 respectively.

While blocks 1004, 1016, and 1006 are shown in FIG. 10 as being performed serially and in a certain order, one of ordinary skill will appreciate that the functions of blocks 1004, 1016, and 1006 can be performed in parallel or in a serial manner, and that the functions of blocks 1004, 1016, and 1006 can be performed in any suitable order. For example, in some implementations, the check maturity 1016 and maturity check 1006 blocks can be performed before (or in parallel with) the relevant tracker check 1004. One of ordinary skill will also appreciate that one or more of the blocks 1012, 1004, 1016, and 1006 can be omitted from the process 1000, and that any combination or sub-combination of the blocks 1012, 1004, 1016, and 1006 can be performed by the process.

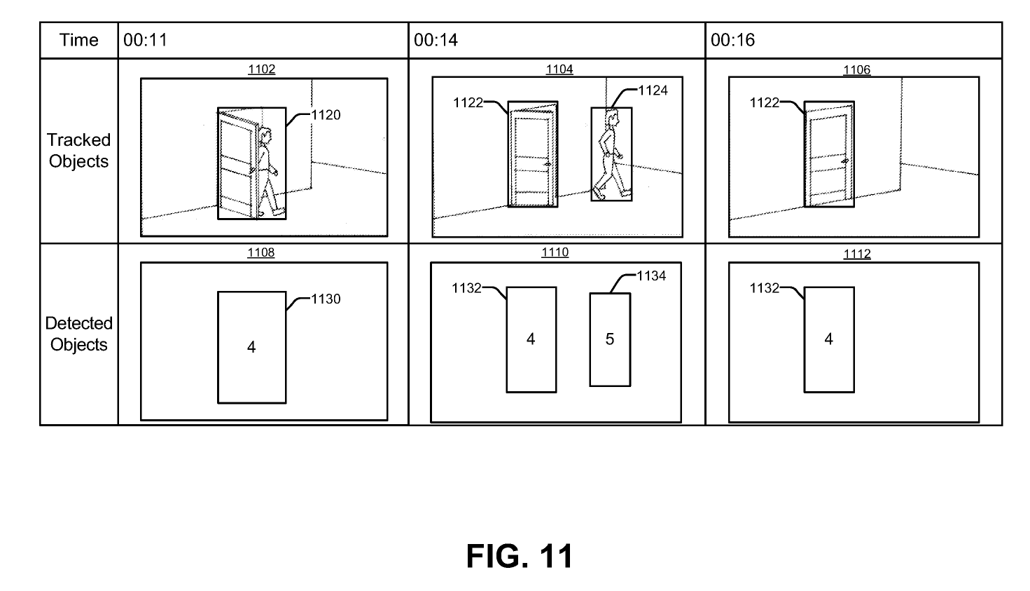

FIG. 11 illustrates an example sequence of video frames 1102, 1104, 1106 in which an object may be detected by the sleeping object detection system as a sleeping object, but is determined by the relevant tracker check to be a false positive. In the illustrated example, the video frames 1102, 1104, 1106 each include tracked objects, where the tracked objects are indicated with bounding boxes 1120, 1122, 1124. The example also includes background pictures 1108, 1110, 1112 that correspond to the video frames 1102, 1104, 1106, In the background pictures 1108, 1110, 1112, object trackers 1130, 1132, 1134 for the bounding boxes 1120, 1122, 1124 in the video frames 1102, 1104, 1106 are illustrated, with tracker labels.

In the example of FIG. 11, at a time instance 00:11, a first video frame 1102 shows a door in a hallway that has opened due to a person stepping through the door. The moving door and person detected by the object tracking system as a single object, and the single object is assigned a bounding box 1120. In the corresponding background picture 1108, the object tracking system generates a tracker 1130 and assigns the tracker 1130 a label “4.”

At a time instance 00:14, a second video frame 1104 shows that the person has walked away from the door while the door swings closed. The object tracking system determines that a split has occurred, with the bounding box 1120 identified in the first video frame 1102 having split into two bounding boxes, one bounding box 1122 for the door and one bounding box 1124 for the person. In the corresponding background picture 1110, the tracker 1134 for the person is assigned a new label “5.” The tracker 1132 for the door may be assigned the label “4” based on the tracker 1132 being similar in size and/or in the same location as the tracker 1130 from the first background picture 1108.

In a third video frame 1106, at a time instance 00:16, the person has left the scene and the door has swung shut. After this video frame 1106, because the door may begin vanishing into the background, the sleeping object detection system may determine that the door is a sleeping object, and may transition the tracker 1132 for the door to the sleeping state. For example, the sleeping object detection system may generate a target sleeping bounding box from the bounding box 1122 for the door.

When the sleeping object detection system includes a false positive checker, however, a relevant tracker check in the false positive checker can identify the door as a false positive. For example, for the third video frame 1106 or in a subsequent video frame, when the sleeping object detection system determines that the tracker 1132 for the door is a candidate sleeping tracker, the relevant tracker check can examine any relevant trackers. In the illustrated example, the relevant tracker check 1004 can determine that the tracker 1132 for the door was the result of a split event that occurred in the second video frame 1104. The split event resulted in two object trackers 1132, 1134. The relevant tracker check can next examine each tracker 1132, 1134 in the split group. In the third video frame 1106, the tracker 1134 for the person has become lost, and thus is removed from consideration. The tracker 1132 for the door is still present in the third video frame 1106, thus the relevant tracker check next determines whether the tracker 1132 is within the target sleeping bounding box. In this case, the tracker 1132 overlaps with the target sleeping bounding box (e.g., the bounding box 1122 for the door). The relevant tracker check thus determines that the tracker 1132 should not be a sleeping tracker. In subsequent video frames, the tracker 1132 may be removed or may be removed from consideration by the sleeping object detection system so that the door can vanish into the background.

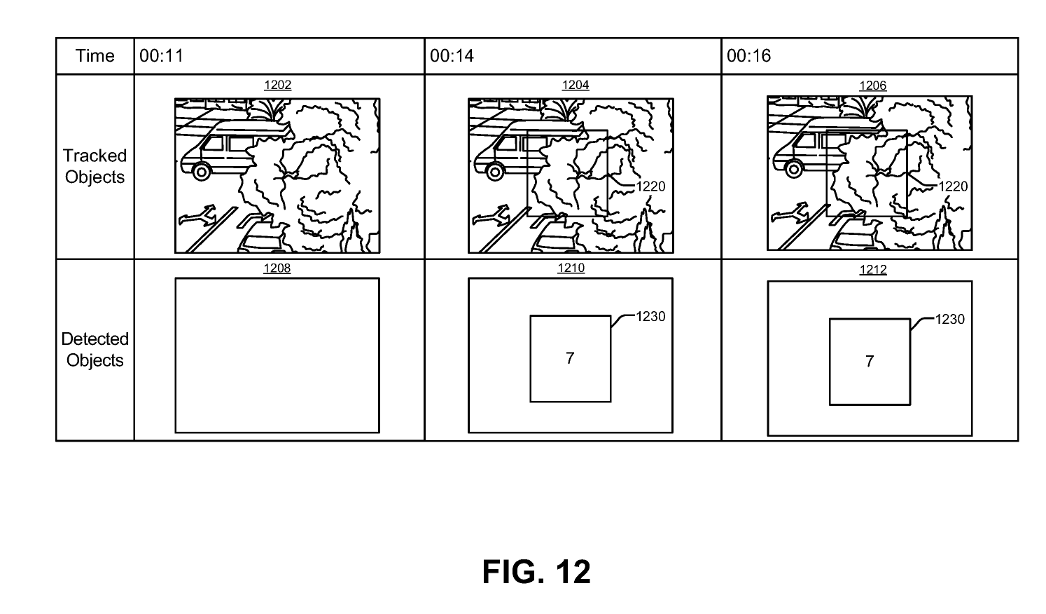

FIG. 12 illustrates an example of a sequence of video frames 1202, 1204, 1206 that include an object that may be detected as a sleeping object, but that is determined to be a false positive by the maturity check. In the illustrated example, the video frames 1202, 1204, 1206 include a tree that occasionally moves due to the wind, and thus is tracked as a moving object. The example also includes background pictures 1208, 1210, 1212 that correspond to the video frames 1202, 1204, 1206.

In the example of FIG. 12, at a time instance 00:11, a tree is visible in the first video frame 1202. For this video frame, the object tracking system has determined that the tree, whose pixels are static, is part of the background. The corresponding background picture 1208 thus shows no object trackers.

In the second video frame 1204, at time instance 00:14, a part of the tree has moved, possibly due to the wind. The moving part of the tree is identified by a bounding box 1220 in the video frame 1204, and an object tracker 1230 on the corresponding background picture 1210.

In the third video frame 1206, at time instance 00:16, the tree has stopped moving. The bounding box 1220 and the tracker 1230 remain, however, because in other situations the object associated with the bounding box 1220 and tracker 1230 may begin moving again (e.g., when the object is a person). In subsequent frames, however, the tree does not move again, and thus begins vanishing into the background. When the tree begins to vanish, the sleeping object detection system may determine that the part of the tree that moved should be a sleeping object.

In the example of FIG. 12, a relevant tracker check of a false positive checker would not identify the moving part of the tree as a false positive. In this example, no split event has occurred. A maturity check, however, could determine that the moving part of the tree is a false positive. For example, the tree may have moved for a duration of only two to ten frames (after the tracker 1230 for the tree becomes a normal tracker). In this example, the duration threshold may be 100, in which case the duration requirement is not met. Alternatively or additionally, as a further example, the moving part of the tree may have only moved two to five pixels to the left and right during the duration. In this example, the movement of the tree over the duration may be too small to meet the movement threshold. When neither the duration threshold nor the movement threshold have been met, the maturity check fails and the tracker 1230 for the tree is not transitioned to a sleeping tracker.

The following is an example of code that can be used to implement the maturity check. In this example, bbbox[i] is an array of bounding boxes, representing the history of a tracker, where i ranges from 0 to n. Each bounding box is defined by the top-left coordinate (rectTopLeftX, recTopLeftY) and a width and height, denoted recWidth and recHeight, respectively. The spatial image resolution being processed in this example is provided by imageWidth and imageHeight.

```
if (tDuration <T)
    return false;
iAvgWidth = 0;
iAvgHeight = 0;
for (i = 0; i<8; i++) {
    box = bbox[i*( tDuration >> 3)];
    iAvgWidth += Box1.rectWidth;
    iAvgHeight += Box1.rectHeight;
}
iAvgWidth >>= 3;
iAvgHeight>>= 3;
iGlobalMoveX = abs(bbox[0] rectTopLeftX −
bbox[tDuration−1].rectTopLeftX);
iGlobalMoveY = abs(bbox[0].rectTopLeftY −
bbox[tDuration−1]. rectTopLeftY);
iAvgWidth = MAX(32, MIN(iAvgWidth, (imageWidth >>3)));
iAvgHeight = MAX(32, MIN(iAvgHeight, (imageHeight >> 3)));
fMoveRatioX = iGlobalMoveX / iAvgWidth;
fMoveRatioY = iGlobalMoveY / iAvgHeight;
fMoveRatio = MAX(fMoveRatioX,fMoveRatioY);
if (fMoveRatio<1.0)
    return false;
fMove = tDuration*fMoveRatio
if (fmove>iCombinedThreshold)
    return true;
return false;
```

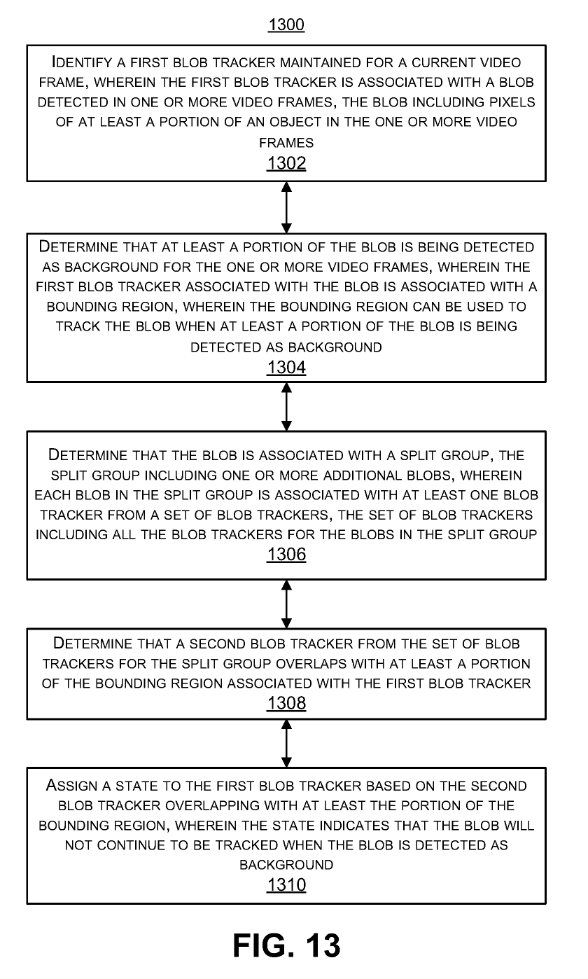

FIG. 13 illustrates an example of a process 1300 for checking candidate sleeping trackers as possible false positives, as described herein. At 1302, the process 1300 includes identifying a first blob tracker maintained for a current video frame, wherein the first blob tracker is associated with a blob detected in one or more video frames, the blob including pixels of at least a portion of a foreground object in the one or more video frames.

At 1304, the process 1300 includes determining that at least a portion of the blob is being detected as background for the one or more video frames, wherein the first blob tracker associated with the blob is associated with a bounding region, and wherein the bounding region can be used to track the blob when at least a portion of the blob is being detected as background. The bounding region, which is also referred to herein as a target sleeping bounding box (or other suitably-shaped region), can be used to track a sleeping object, where a sleeping object is associated with a blob that is still (e.g., not moving or moving too slowly to be detected as a foreground object) over multiple video frames. In some implementations, determining that at least a portion of the blob is being detected as background includes determining that a current bounding region associated with the blob has decreased in size relative to a size of a previous bounding region associated with the blob. In some cases, these implementations further include determining that a color characteristic of pixels associated with the current bounding region are similar to a color characteristic of pixels associated with the previous bounding region.

At 1306, the process 1300 includes determining that the blob is associated with a split group, the split group including one or more additional blobs, wherein each blob in the split group is associated with at least one blob tracker from a set of blob trackers. For example, a first blob from the split group can be associated with a first blob tracker, and a second blob from the split group can be associated with a second blob tracker. In such an example, the first blob or the second blob can include the blob associated with the blob tracker and that is determined to be associated with the split group. The set of blob trackers include all the blob trackers for the blobs in the split group. The split group can result from a single blob detected in a previous video frame being detected as the blob and the one or more additional blobs in a subsequent video frame. The subsequent video frame occurs later in time than the previous video frame. In some cases, the subsequent video frame is the current video frame.

At 1308, the process 1300 includes determining that a second blob tracker from the set of blob trackers for the split group overlaps with at least a portion of the bounding region associated with the first blob tracker. In some cases, the second blob tracker is determined to overlap with at least a portion of the bounding region when the second blob tracker overlaps the bounding region by a threshold amount (e.g. by 50%, 75%, or some other suitable amount).

At 1310, the process 1300 includes assigning a state to the first blob tracker based on the second blob tracker overlapping with at least the portion of the bounding region, wherein the state indicates that the blob will not continue to be tracked when the blob is detected as background. The blob will instead be allowed to fade into the background. Otherwise, when all blob trackers from the set of blob trackers are lost or do not overlap with at least a portion of the bounding region, the first blob tracker is transitioned to a sleeping state. The sleeping state can enable the first blob tracker to track the blob for the current video frame.

In some implementations, the process 1300 further includes determining that the second blob tracker from the set of blob trackers is not a lost blob tracker. A lost blob tracker is associated with a blob that is not detected in the current video frame. In these implementations, the process 1300 further includes assigning the state to the first blob tracker based on the second blob tracker overlapping with at least the portion of the bounding region and based on the second blob tracker not being a lost blob tracker.

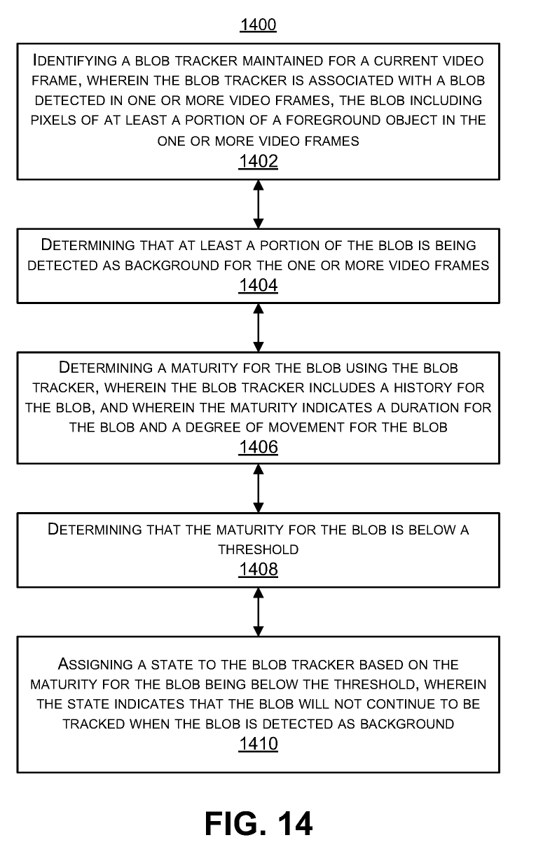

FIG. 14 illustrates an example of a process 1400 for checking candidate sleeping trackers for possible false positives, as described herein. At 1402, the process includes identifying a blob tracker maintained for a current video frame, wherein the blob tracker is associated with a blob detected in one or more video frames, the blob including pixels of at least a portion of a foreground object in the one or more video frames.

At 1404, the process 1400 includes determining that at least a portion of the blob is being detected as background for the one or more video frames. In some implementations, determining that at least a portion of the blob is being detected as background includes determining that a current bounding region associated with the blob has decreased in size relative to a size of a previous bounding region associated with the blob. These implementations further include determining that a color characteristic of pixels associated with the current bounding region are similar to a color characteristic of pixels associated with the previous bounding region.

At 1406, the process 1400 includes determining a maturity for the blob using the blob tracker, wherein the blob tracker includes a history for the blob, and wherein the maturity indicates a duration for the blob and a degree of movement for the blob. The duration can include a count of video frames since the blob tracker and the blob were output as a tracker-blob pair. In some implementations, the history for the blob includes a set of bounding regions determined for the blob for a set of previous video frames. In these implementations, the degree of movement is determined using coordinates for the set of bounding regions.

At 1408, the process 1400 includes determining that the maturity for the blob is below a threshold. In some implementations, the maturity for the blob is below the threshold when the duration for the blob is below a duration threshold. In some implementations, the maturity for the blob is below the threshold when the degree of movement for the blob is below a movement threshold. In some implementations, when the duration for the blob is greater than or equal to a duration threshold and the degree of movement is greater than or equal to a movement threshold, the blob tracker is transitioned to a sleeping state. The sleeping state enables the blob tracker to track the blob for the current video frame.

At 1410, the process 1400 includes assigning a state to the blob tracker based on the maturity for the blob being below the threshold, wherein the state indicates that the blob will not continue to be tracked when the blob is detected as background.

In some examples, the processes 1300, 1400 may be performed by a computing device or an apparatus, such as the video analytics system 100. For example, the processes 1300, 1400 can be performed by the video analytics system 100 and/or the object tracking system 106 shown in FIG. 1. In some cases, the computing device or apparatus may include a processor, microprocessor, microcomputer, or other component of a device that is configured to carry out the steps of processes 1300, 1400. In some examples, the computing device or apparatus may include a camera configured to capture video data (e.g., a video sequence) including video frames. For example, the computing device may include a camera device (e.g., an IP camera or other type of camera device) that may include a video codec. In some examples, a camera or other capture device that captures the video data is separate from the computing device, in which case the computing device receives the captured video data. The computing device may further include a network interface configured to communicate the video data. The network interface may be configured to communicate Internet Protocol (IP) based data.

The processes 1300, 1400 are illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 1300, 1400 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The video analytics operations discussed herein may be implemented using compressed video or using uncompressed video frames (before or after compression). An example video encoding and decoding system includes a source device that provides encoded video data to be decoded at a later time by a destination device. In particular, the source device provides the video data to the destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming devices, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by the source device. The destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. The destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of the source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above is merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. The source device and the destination device are merely examples of such coding devices in which the source device generates coded video data for transmission to the destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if the video source is a video camera, the source device and the destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. An apparatus for maintaining blob trackers for video frames, comprising:
a memory configured to store video data associated with the video frames; and
a processor configured to:
identify a first blob tracker maintained for a current video frame, wherein the first blob tracker is associated with a blob detected in one or more video frames, the blob including pixels of at least a portion of an object in the one or more video frames;
determine that at least a portion of the blob is being detected as background for the one or more video frames, wherein the first blob tracker associated with the blob is associated with a bounding region, wherein the bounding region can be used to track the blob when at least a portion of the blob is being detected as background;
determine that the blob is associated with a split group, the split group including one or more additional blobs, wherein each blob in the split group is associated with at least one blob tracker from a set of blob trackers, the set of blob trackers including all the blob trackers for the blobs in the split group;
determine that a second blob tracker from the set of blob trackers for the split group overlaps with at least a portion of the bounding region associated with the first blob tracker; and
assign a state to the first blob tracker based on the second blob tracker overlapping with at least the portion of the bounding region, wherein the state indicates that the blob will not continue to be tracked when the blob is detected as background.

2. The apparatus of claim 1, wherein the second blob tracker from the set of blob trackers overlaps with at least the portion of the bounding region when the second blob tracker overlaps the bounding region by a threshold amount.

3. The apparatus of claim 1, wherein the processor is further configured to:
determine that the second blob tracker from the set of blob trackers is not a lost blob tracker, wherein a lost blob tracker is associated with a blob that is not detected in the current video frame; and
assign the state to the first blob tracker based on the second blob tracker overlapping with at least the portion of the bounding region and based on the second blob tracker not being a lost blob tracker.

4. The apparatus of claims 1, wherein, when all blob trackers from the set of blob trackers are lost or do not overlap with at least a portion of the bounding region, the first blob tracker is transitioned to a sleeping state, wherein the sleeping state enables the first blob tracker to track the blob for the current video frame.

5. The apparatus of claim 1, wherein the split group results from a single blob detected in a previous video frame being detected as the blob and the one or more additional blobs in a subsequent video frame, the subsequent video frame occurring later in time than the previous video frame.

6. The apparatus of claim 1, wherein determining that at least a portion of the blob is being detected as background includes:
determining that a current bounding region associated with the blob has decreased in size relative to a size of a previous bounding region associated with the blob; and
determining that a color characteristic of pixels associated with the current bounding region are similar to a color characteristic of pixels associated with the previous bounding region.

7. The apparatus of claim 1, wherein the bounding region can be used to track a sleeping object, wherein a sleeping object is associated with a blob that is still over multiple video frames.

8. The apparatus of claim 1, further comprising a camera configured to capture the video frames, and a display configured to display the video frames.

9. A method of maintaining blob trackers for video frames, the method comprising:
identifying a first blob tracker maintained for a current video frame, wherein the first blob tracker is associated with a blob detected in one or more video frames, the blob including pixels of at least a portion of an object in the one or more video frames;
determining that at least a portion of the blob is being detected as background for the one or more video frames, wherein the first blob tracker associated with the blob is associated with a bounding region, wherein the bounding region can be used to track the blob when at least a portion of the blob is being detected as background;
determining that the blob is associated with a split group, the split group including one or more additional blobs, wherein each blob in the split group is associated with at least one blob tracker from a set of blob trackers, the set of blob trackers including all the blob trackers for the blobs in the split group;
determining that a second blob tracker from the set of blob trackers for the split group overlaps with at least a portion of the bounding region associated with the first blob tracker; and
assigning a state to the blob tracker based on the second blob tracker overlapping with at least the portion of the bounding region, wherein the state indicates that the blob will not continue to be tracked when the blob is detected as background.

10. The method of claim 9, wherein the second blob tracker from the set of blob trackers overlaps with at least the portion of the bounding region when the second blob tracker overlaps the bounding region by a threshold amount.

11. The method of claim 9, further comprising:
determining that the second blob tracker from the set of blob trackers is not a lost blob tracker, wherein a lost blob tracker is associated with a blob that is not detected in the current video frame; and
assigning the state to the blob tracker based on the second blob tracker overlapping with at least the portion of the bounding region and based on the second blob tracker not being a lost blob tracker.

12. The method of claim 9, wherein, when all blob trackers from the set of blob trackers are lost or do not overlap with at least a portion of the bounding region, the first blob tracker is transitioned to a sleeping state, wherein the sleeping state enables the first blob tracker to track the blob for the current video frame.

13. The method of claim 9, wherein the split group results from a single blob detected in a previous video frame being detected as the blob and the one or more additional blobs in a subsequent video frame, the subsequent video frame occurring later in time than the previous video frame.

14. The method of claim 9, wherein determining that at least a portion of the blob is detected as background includes:
determining that a current bounding region associated with the blob has decreased in size relative to a size of a previous bounding region associated with the blob; and
determining that a color characteristic of pixels associated with the current bounding region are similar to a color characteristic of pixels associated with the previous bounding region.

15. The method of claim 9, wherein the bounding region can be used to track a sleeping object, wherein a sleeping object is associated with a blob that is still over multiple video frames.

16. A non-transitory computer-readable medium having stored thereon instructions that, when executed by one or more processors, cause the one or more processor to:
identify a first blob tracker maintained for a current video frame, wherein the first blob tracker is associated with a blob detected in one or more video frames, the blob including pixels of at least a portion of a foreground object in the one or more video frames;
determine that at least a portion of the blob is being detected as background for the one or more video frames, wherein the first blob tracker associated with the blob is associated with a bounding region, wherein the bounding region can be used to track the blob when at least a portion of the blob is being detected as background;
determine that the blob is associated with a split group, the split group including one or more additional blobs, wherein each blob in the split group is associated with at least one blob tracker from a set of blob trackers, the set of blob trackers including all the blob trackers for the blobs in the split group;
determine that a second blob tracker from the set of blob trackers for the split group overlaps with at least a portion of the bounding region associated with the first blob tracker; and
assign a state to the first blob tracker based on the second blob tracker overlapping with at least the portion of the bounding region, wherein the state indicates that the blob will not continue to be tracked when the blob is detected as background.

17. The non-transitory computer-readable medium of claim 16, wherein the second blob tracker from the set of blob trackers overlaps with at least the portion of the bounding region when the second blob tracker overlaps the bounding region by a threshold amount.

18. The non-transitory computer-readable medium of claim 16, further including instructions that, when executed by the one or more processors, cause the one or more processors to:
determine that the second blob tracker from the set of blob trackers is not a lost blob tracker, wherein a lost blob tracker is associated with a blob that is not detected in the current video frame; and
assign the state to the first blob tracker based on the second blob tracker overlapping with at least the portion of the bounding region and based on the second blob tracker not being a lost blob tracker.

19. The non-transitory computer-readable medium of claim 16, wherein, when all blob trackers from the set of blob trackers are lost or do not overlap with at least a portion of the bounding region, the first blob tracker is transitioned to a sleeping state, wherein the sleeping state enables the first blob tracker to track the blob for the current video frame.

20. The non-transitory computer-readable medium of claim 16, wherein the split group results from a single blob detected in a previous video frame being detected as the blob and the one or more additional blobs in a subsequent video frame, the subsequent video frame occurring later in time than the previous video frame.

21. The non-transitory computer-readable medium of claim 16, wherein determining that at least a portion of the blob is detected as background includes:
determining that a current bounding region associated with the blob has decreased in size relative to a size of a previous bounding region associated with the blob; and
determining that a color characteristic of pixels associated with the current bounding region are similar to a color characteristic of pixels associated with the previous bounding region.

22. The non-transitory computer-readable medium of claim 16, wherein the bounding region can be used to track a sleeping object, wherein a sleeping object is associated with a blob that is still over multiple video frames.

23. An apparatus for maintaining blob trackers for one or more video frames, comprising:
means for identifying a first blob tracker maintained for a current video frame, wherein the blob tracker is associated with a blob detected in one or more video frames, the blob including pixels of at least a portion of a foreground object in the one or more video frames;
means for determining that at least a portion of the blob is being detected as background for the one or more video frames, wherein the first blob tracker associated with the blob is associated with a bounding region, wherein the bounding region can be used to track the blob when at least a portion of the blob is being detected as background;
means for determining that the blob is associated with a split group, the split group including one or more additional blobs, wherein each blob in the split group is associated with at least one blob tracker from a set of blob trackers, the set of blob trackers including all the blob trackers for the blobs in the split group;
means for determining that a second blob tracker from the set of blob trackers for the split group overlaps with at least a portion of the bounding region associated with the first blob tracker; and
means for assigning a state to the first blob tracker based on the second blob tracker overlapping with at least the portion of the bounding region, wherein the state indicates that the blob will not continue to be tracked when the blob is detected as background.

24. The apparatus of claim 23, wherein the second blob tracker from the set of blob trackers overlaps with at least the portion of the bounding region when the second blob tracker overlaps the bounding region by a threshold amount.

25. The apparatus of claim 23, further comprising:
means for determining that the second blob tracker from the set of blob trackers is not a lost blob tracker, wherein a lost blob tracker is associated with a blob that is not detected in the current video frame; and
means for assigning the state to the first blob tracker based on the second blob tracker overlapping with at least the portion of the bounding region and based on the second blob tracker not being a lost blob tracker.

26. The apparatus of claim 23, wherein, when all blob trackers from the set of blob trackers are lost or do not overlap with at least a portion of the bounding region, the first blob tracker is transitioned to a sleeping state, wherein the sleeping state enables the first blob tracker to track the blob for the current video frame.

27. The apparatus of claim 23, wherein the split group results from a single blob detected in a previous video frame being detected as the blob and the one or more additional blobs in a subsequent video frame, the subsequent video frame occurring later in time than the previous video frame.

28. The apparatus of claim 23, wherein the means for determining that at least a portion of the blob is detected as background includes:
means for determining that a current bounding region associated with the blob has decreased in size relative to a size of a previous bounding region associated with the blob; and
means for determining that a color characteristic of pixels associated with the current bounding region are similar to a color characteristic of pixels associated with the previous bounding region.

29. The apparatus of claim 23, wherein the bounding region can be used to track a sleeping object, wherein a sleeping object is associated with a blob that is still over multiple video frames.
